(19) United States
(12) Patent Application Publication
(10) Pub. No.: US 2012/0025716 A1
(43) Pub. Date: Feb. 2, 2012

(54) BACKLIGHT DEVICE AND DISPLAY DEVICE

(75) Inventors: Hideyuki Nakanishi, Osaka (JP); Yoshio Umeda, Hyogo (JP); Toshiki Onishi, Osaka (JP); Seiji Hamada, Osaka (JP)

(73) Assignee: PANASONIC CORPORATION, Kadoma-shi, Osaka (JP)

(21) Appl. No.: 13/262,744

(22) PCT Filed: Sep. 28, 2010
(86) PCT No.: PCT/JP2010/005817

§ 371 Date: Oct. 3, 2011

(30) Foreign Application Priority Data
Sep. 30, 2009 (JP) 2009-228299

(51) Int. Cl. H05B 37/02

(52) U.S. Cl. 315/152; 315/297

(57) ABSTRACT

Disclosed is a backlight device that suppresses the increase of maximum power consumption. A light-emitting unit (121) is provided with a plurality of light-emitting areas that individually emit illumination light. A power estimation unit (136) estimates the power consumption of the light-emitting unit (121). A duty lower-limit setting unit (137) varies the range in which drive conditions that include the duty and peak value of a drive pulse for causing each of the plurality of light-emitting areas to emit light can be set, in accordance with changes in the estimated power consumption. A drive condition specification unit specifies the drive conditions for each of the plurality of light-emitting areas within the varied range. An LED driver (123) drives each of the plurality of light-emitting areas under the specified drive conditions.

### TECHNICAL FIELD

The present invention relates to a backlight apparatus and a display apparatus using a backlight apparatus.

### BACKGROUND ART

A non-self-luminous display apparatus, typified by a liquid crystal display apparatus, has a backlight apparatus (or hereinafter simply referred to as “backlight”) in the back. A display apparatus of this kind displays an image through an optical modulation section, which adjusts the amount of light which is reflected or which transmits, in the light emitted from the backlight, in accordance with image signals. Also, a display apparatus of this kind turns on and off a light source intermittently in synchronization with scanning of images, in order to improve the movie blur with a display apparatus of a hold type drive.

Generally, as examples of this intermittent lighting, there are a scheme of making an entire light emitting surface of a backlight flash with predetermined timing (which is generally referred to as “backlight blink”) and a scheme of dividing a light emitting surface of a backlight into a plurality of scan areas in vertical directions as shown in FIG. 1 and making the individual scan areas flash sequentially in synchronization with scanning of images as shown in FIG. 2 (which is generally referred to as “backlight scan”).

For example, the liquid crystal display apparatus of the backlight blink scheme disclosed in patent literature 1 controls the drive duty (hereinafter also referred to as “duty”) and drive current (hereinafter also referred to as “peak value”) of a light source by determining whether an input image is a still image or a moving image.

For example, the liquid crystal display apparatus of the backlight scan scheme disclosed in patent literature 2 controls the drive duty of a light source in accordance with the scale of motion in an image.

### CITATION LIST

### Patent Literature

PTL 1
Japanese Patent Publication No. 3535799
PTL 2
Japanese Patent Application Laid-Open No. 2006-323300

### SUMMARY OF INVENTION

### Technical Problem

With the liquid crystal display apparatus disclosed in above patent literature 2, even when an input image is a movie, if the image in part of an image display area corresponding to part of scan areas is not moving, the drive duty in that scan area is not lowered and is maintained. That is to say, it is possible to prevent movie blur and improve movie resolution by not lowering the drive duty in part of scan areas and by lowering the drive duty only in the other scan areas.

In this case, in order to maintain the same brightness in all scan areas, it is necessary to increase the drive current in scan areas where the drive duty is lowered, compared to scan areas where the drive duty is not lowered.

Now, if the kind of light source that does not lower the rate of light emission even when the drive current is increased is used as the backlight, controlling the light source to increase the drive current simply by the magnitude the drive duty is decreased, is sufficient.

However, if a general light source to reduce that lowers the rate of light emission when the drive current increases (e.g. LED: Light Emitting Diode) is used, the control to increase the drive current to achieve predetermined brightness needs to be carried out to an extent to compensate for the lowering of light emission rate. In this case, the power consumption increases.

Furthermore, when the scale of motion in an image is greater in a greater number of image display areas, a light source of a greater number of scan areas operates at low efficiency, and, as a result of this, increase in power consumption becomes distinct.

Furthermore, regardless of the light emission characteristic of a light source, backlight power consumption increases when the light adjustment value of a light source, which is derived from an image signal, increases (in other words, when the brightness of a light source needs to be increased). Consequently, even when the light adjustment value of a large number of light sources power consumption increases distinctly.

Thus, a backlight apparatus which controls both drive duty and drive current per divided area such as a scan area has a problem of increasing maximum power consumption and incurring increased costs of a power supply circuit and light source drive circuit.

It is therefore an object of the present invention to provide a backlight apparatus and display apparatus that can reduce the increases of maximum power consumption.

### Solution to Problem

A backlight apparatus according to the present invention has: a light emitting section that has a plurality of light emitting areas to emit light individually; a power estimation section that estimates power consumption of the light emitting section; a drive condition changing section that changes a range that can be designated with respect to drive conditions including duties and peak values of drive pulses for allowing the plurality of light emitting areas to emit light, in accordance with change of estimated power consumption; a drive condition designating section that designates the drive conditions of the plurality of light emitting areas in changing ranges; and a drive section that drives the plurality of light emitting areas individually based on the designated drive conditions.

A display apparatus according to the present invention has: the above backlight apparatus; and a light modulation section that displays an image by modulating an illuminating light from the plurality of light emitting areas in accordance with an image signal.

### Advantageous Effects of Invention

With the present invention, it is possible to reduce the increase of the maximum power consumption of a backlight apparatus.

### BRIEF DESCRIPTION OF DRAWINGS

FIG. 1 shows an example of a conventional scan area;

FIG. 2 shows a conventional backlight scanning method;

FIG. 3 is a block diagram showing a configuration of a liquid crystal display apparatus according to embodiment 1 of the present invention;

FIG. 4 shows an image display areas on a liquid crystal panel according to embodiment 1 of the present invention;

FIG. 5 shows light emitting areas and scan areas in a display section according to embodiment 1 of the present invention;

FIG. 6 is a block diagram showing a configuration of an LED driver according to embodiment 1 of the present invention;

FIG. 7 shows a macroblock segmented from the image display area according to embodiment 1 of the present invention;

FIG. 8 is a block diagram showing a configuration for a motion amount detection section according to embodiment 1 of the present invention;

FIG. 9A shows a first example of a drive duty calculation method based on the amount of motion, according to embodiment 1 of the present invention;

FIG. 9B shows a second example of a drive duty calculation method based on the amount of motion, according to embodiment 1 of the present invention;

FIG. 9C shows a third example of a drive duty calculation method based on the amount of motion, according to embodiment 1 of the present invention;

FIG. 10 shows a relationship between drive duty and drive current according to embodiment 1 of the present invention;

FIG. 11A shows examples of ON/OFF signal waveforms controlled by a scan controller according to embodiment 1 of the present invention;

FIG. 11B shows the duties of the ON/OFF signals shown in FIG. 11A;

FIG. 12A shows other examples of ON/OFF signal waveforms controlled by a scan controller according to embodiment 1 of the present invention;

FIG. 12B shows the duties of the ON/OFF signals shown in FIG. 12A;

FIG. 13 shows a method of setting a lower-limit duty value based on power consumption, according to embodiment 1 of the present invention;

FIG. 14 shows an operation of motion amount detection per image display area according to embodiment 1 of the present invention;

FIG. 15 shows drive pulses per light emitting area, in the event the lower-limit duty value is set on a variable basis, according to embodiment 1 of the present invention;

FIG. 16 shows drive pulses per light emitting area, in the event the lower-limit duty value is not set on a variable basis, according to embodiment 1 of the present invention;

FIG. 17 is a block diagram showing a configuration of a liquid crystal display apparatus according to embodiment 2 of the present invention;

FIG. 18 is a block diagram showing a configuration of a liquid crystal apparatus according to embodiment 3 of the present invention;

FIG. 19 is a block diagram showing a configuration of a liquid crystal display apparatus according to embodiment 4 of the present invention;

FIG. 20 is a block diagram showing a configuration of a liquid crystal display apparatus according to embodiment 5 of the present invention;

FIG. 21 is a block diagram showing a configuration of a liquid crystal display apparatus according to embodiment 6 of the present invention;

FIG. 22 shows a method of setting the upper-limit current value based on power consumption, base on embodiment 6 of the present invention;

FIG. 23 is a block diagram showing a configuration of a liquid crystal display apparatus according to embodiment 7 of the present invention;

FIG. 24 shows a method of correcting the amount of motion, according to embodiment 7 of the present invention;

FIG. 25 shows a block diagram showing a method of setting the upper-limit motion amount value based on power consumption, according to embodiment 7 of the present invention;

FIG. 26 is a block diagram showing a configuration of a liquid crystal display apparatus according to embodiment 8 of the present invention;

FIG. 27 shows a method of reducing the detected amount of motion, according to embodiment 8 of the present invention; and

FIG. 28 shows a method of setting a motion amount reduction coefficient based on power consumption, according to embodiment 8 of the present invention.

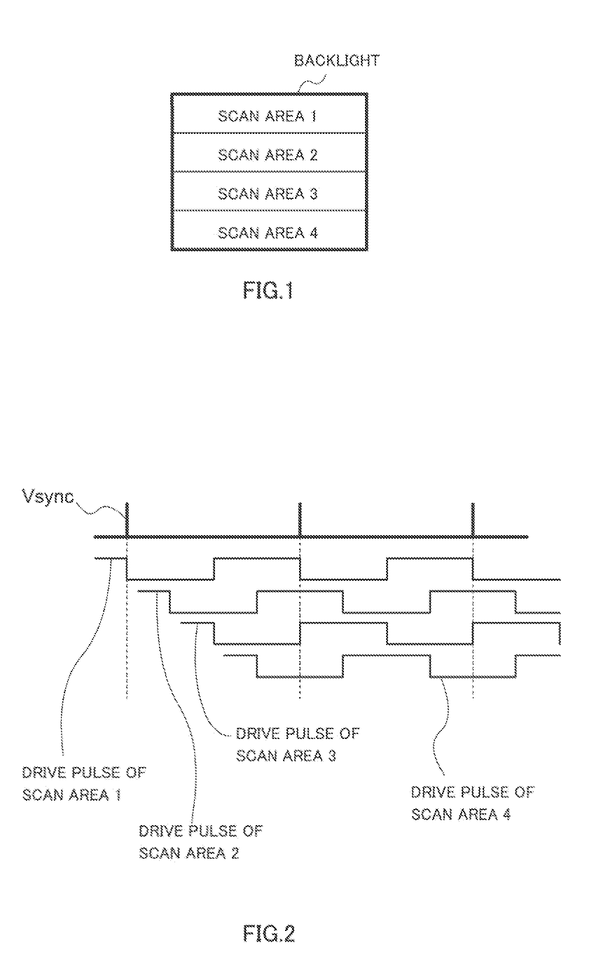

### DESCRIPTION OF EMBODIMENTS

Now, embodiments of the present invention will be described below in detail.

### Embodiment 1

Embodiment 1 of the present invention will be described below.

A case will be described here with the present embodiment where power to be consumed is estimated from the drive duty and peak value, and where, based on the estimation result, the lower-limit value of drive duty is set on a variable basis.

<1-1. Configuration of Liquid Crystal Display Apparatus>

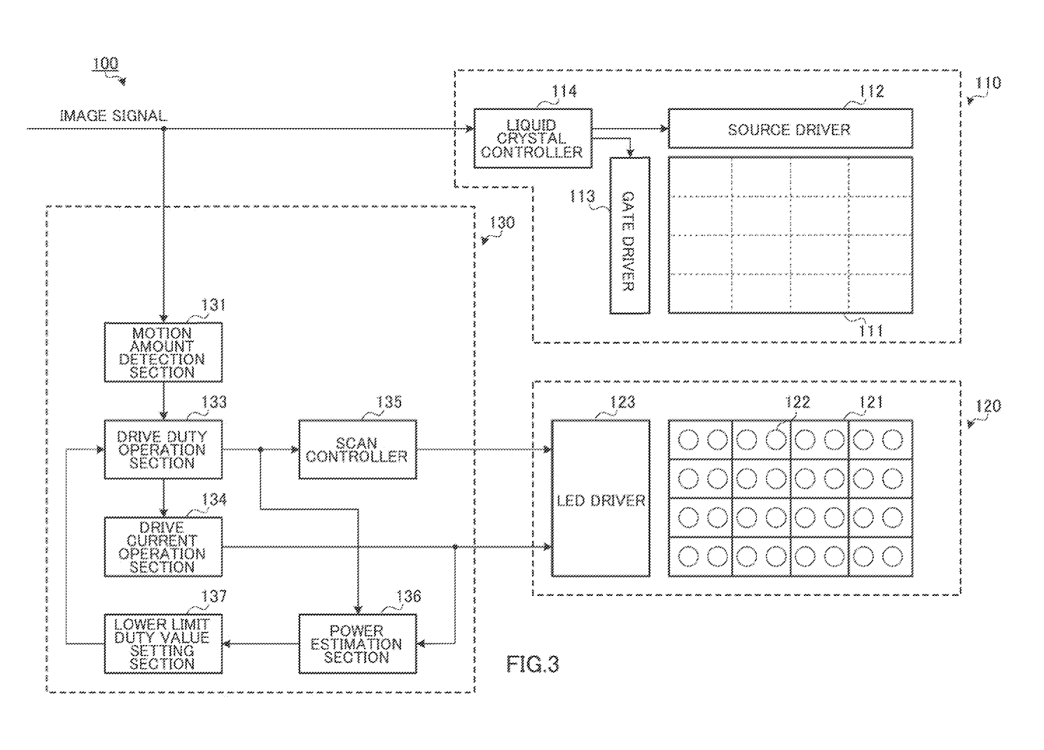

The configuration of a liquid crystal display apparatus will be described first. FIG. 3 is a block diagram showing a configuration of a liquid crystal display apparatus according to the present embodiment. Liquid crystal display apparatus 100 has liquid crystal panel section 110, illuminating section 120 and drive control section 130. Illuminating section 120 and drive control section 130, combined, constitute a backlight apparatus.

The configuration of each component will be described in detail.

<1-1-1. Liquid Crystal Panel Section>

Liquid crystal panel section 110 has liquid crystal panel 111, source driver 112, gate driver 113 and liquid crystal controller 114.

When an image signal is received as input in liquid crystal panel section 110, a signal voltage is applied to each pixel on liquid crystal panel 111 as a display section, from source driver 112 and gate driver 113, with timing controlled by liquid crystal controller 114. Consequently, liquid crystal panel 111 is able to modulate the illuminating light emitted from the back of liquid crystal panel 111 according to image signals, and, by this means, allows an image formed with a plurality of pixels to be displayed on a screen. That is to say, liquid crystal panel section 110 forms an optical modulation section.

Now, in FIG. 3, the screen of liquid crystal panel 111 is divided by broken lines, and this expressly indicates that liquid crystal panel 111 has a plurality of image display areas, not that liquid crystal panel 111 is structurally divided or that these lines are actually displayed in an image. The same applies to the other drawings.

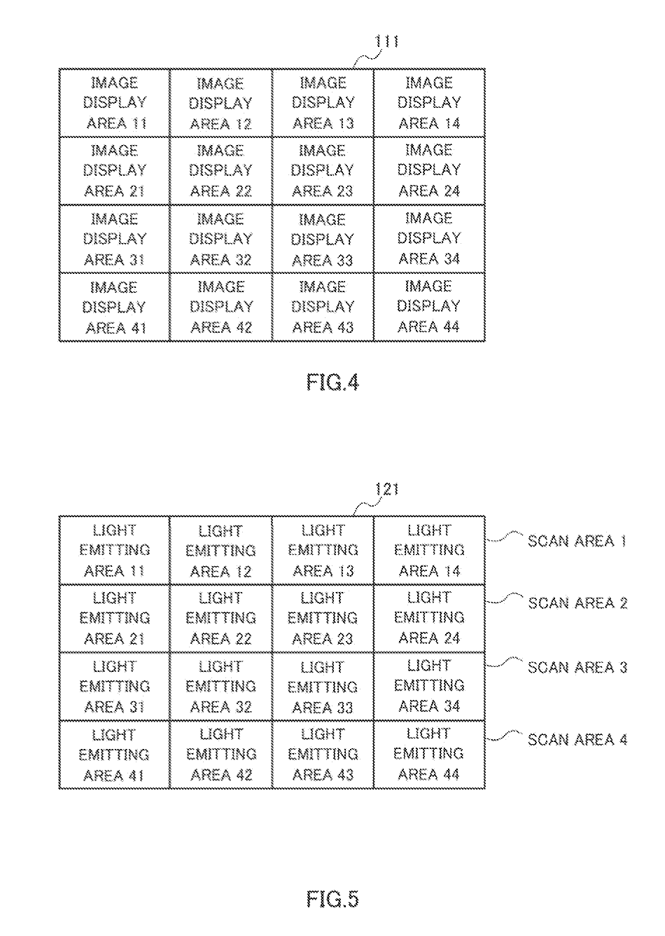

With the present embodiment, as shown in FIG. 4, liquid crystal panel 111 has sixteen image display areas 11-44 obtained by dividing the whole screen in a matrix shape.

Note that liquid crystal panel 111 is able to adopt an IPS (In-Plane Switching) scheme, VA (Vertical Alignment) scheme, and so on, but these are by no means limiting.

<1-1-2. Illuminating Section>

Illuminating section 120 emits illuminating light for displaying an image on liquid crystal panel 111 and emits illuminating light on liquid crystal panel 111 from the back side of liquid crystal panel 111.

Illuminating section 120 has light emitting section 121. Light emitting section 121 adopts a direct-type configuration and is formed by placing a large number of point light sources on the back of a diffusion plate in a planar arrangement, so that light is emitted toward the diffusion plate. By this means, light emitting section 121 outputs, from its front surface side, light that is emitted from a light source and is incident from the back.

The present embodiment uses LEDs 122 as point light sources. LEDs 122 all emit white light, and are configured to emit light at the same brightness if driven by the same drive conditions. Note that each LED 122 emits white light by itself or may be configured to emit white light by mixing RGB lights.

Also note that elements other than LEDs may be used as point light sources, or elements that emit light other than white light may be used as well.

Now, in FIG. 1, the light output surface of light emitting section 121 is divided by solid lines, and this expressly indicates that light emitting section 121 has a plurality of light emitting areas, not that light emitting section 121 is structurally divided. The same applies to other drawings as well.

With the present embodiment, as shown in FIG. 5, light emitting section 121 has sixteen light emitting areas 11-44 obtained by dividing the whole screen in a matrix shape. Light emitting areas 11-14 are included in scan area 1, light emitting areas 21-24 in scan area 2, light emitting areas 31-34 in scan area 3, and light emitting areas 41-44 in scan area 4.

Illuminating section 120 has LED driver 123 as a drive section to drive LEDs 122. LED driver 123 has drive terminals which equal the light emitting areas in number, so as to drive each light emitting area individually.

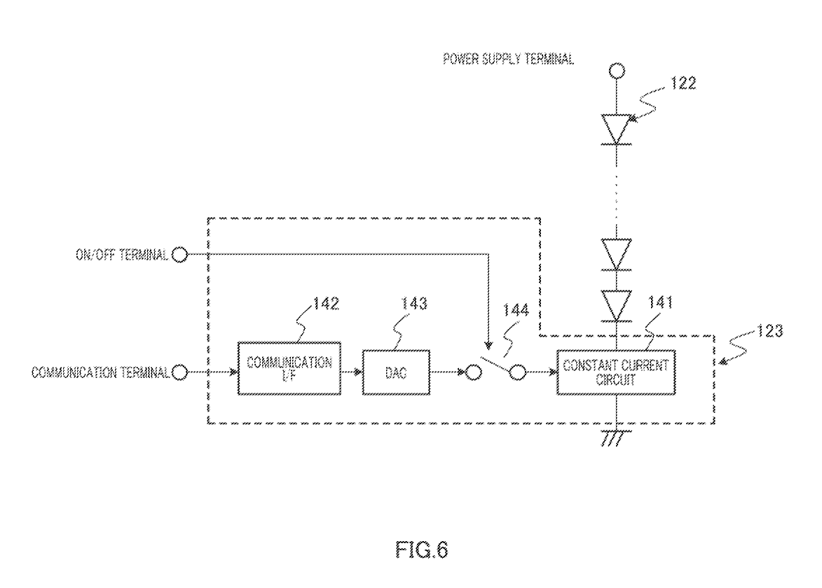

FIG. 6 shows an example of LED drivers 123. LED driver 123 has: constant current circuit 141 that supplies current to a plurality of serially-connected LEDs 122; communication interface (I/F) 142 that receives current value data, which represents the peak value to report to constant current circuit 141, from drive control section 130, via a communication terminal; a digital-to-analog converter (DAC) 143 that converts current value data into a current command signal, which is an analog signal; and switch 144 that allows or blocks input of a current command signal from DAC 143 to constant current circuit 141, according to ON/OFF signals provided from drive control section 130 via ON/OFF terminals. That is to say, LED driver 123 is configured such that a current proportional to the signal voltage of a current command signal is supplied from constant current circuit 141 to LED 122 when switch 144 is turned on and this current supply is blocked when switch 144 is turned off. This configuration is provided per light emitting area.

Given the above configuration, LED driver 123 is able to make a plurality of scan areas be driven and emit light individually by the same drive conditions including the duties (i.e. ON duties) and peak values of drive pulses designated individually on a per scan area basis.

<1-1-3. Drive Control Section>

Drive control section 130 is an operation processing apparatus having motion amount detection section 131, drive duty operation section 133, drive current operation section 134, scan controller 135, power estimation section 136 and lower-limit duty value setting section 137, and controls drive conditions including the duties and peak values of drive pulses on a per scan area basis based on an input image signal in each image display area. In drive control section 130, motion amount correction section 132, drive duty operation section 133, drive current operation section 134 and scan controller 135, combined, constitute a drive condition designating section which designate drive conditions on a per scan area basis.

<1-1-3-1. Motion Amount Detection Section>

Motion amount detection section 131, as a motion detection section, detects the amount of motion in an image based on an input image signal.

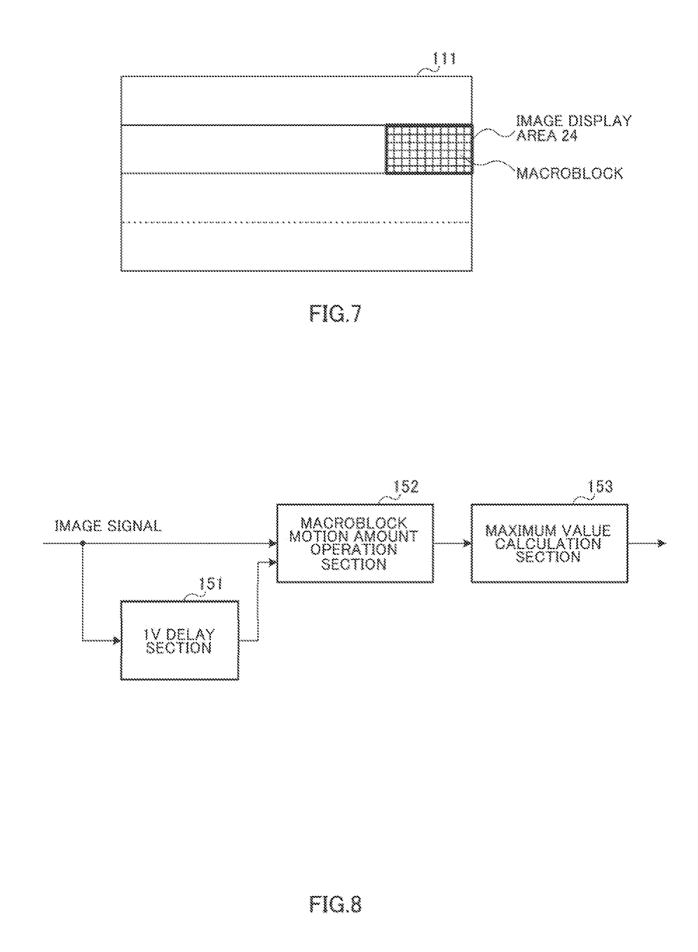

As for the method of detecting the amount of motion, there is, for example, a method of determining the amount of motion by performing pattern-matching of all macroblocks with the previous frame, in macroblock units. Here, macroblocks are individual areas that are defined by dividing image display areas smaller. FIG. 8 shows macroblocks in image display area 2 of liquid crystal panel 111. Note that, as a simpler method of motion detection, there is a method of using the scale of difference of an image signal from the previous frame in the same pixel position.

With the present embodiment, motion amount detection section 131 is configured to output the maximum value of the amounts of motion of macro blocks determined by the former method. That is to say, if the maximum value of the amount of motion is the same between a case where an image over all individual image display areas and a case where an image moves only in part, the same value is output.

FIG. 8 shows a configuration of motion amount detection section 131. Motion amount detection sections 131 has: 1V delay section 151 that delays an input image signal by one frame, macroblock motion amount operation section 152 that operates the amount of motion in an image per macroblock with reference to the image signal of the previous frame, and maximum value calculation section 153 that calculates the maximum value in the amounts of motion operated. This configuration is provided per image display area.

In the above configuration, motion amount detection section 131 detects the amount of motion of image per image display area.

<1-1-3-2. Drive Duty Operation Section>

Drive duty operation section 133 performs an operation for converting an amount of motion, which is detected in and output from motion amount detection section 131, into a drive pulse duty value for each light emitting area. Drive duty operation section 133 determines the drive duty for each scan area, by applying a predetermined conversion formula to the amount of motion detected in each image display area, and determines the result as the drive duty to specify for each light emitting area.

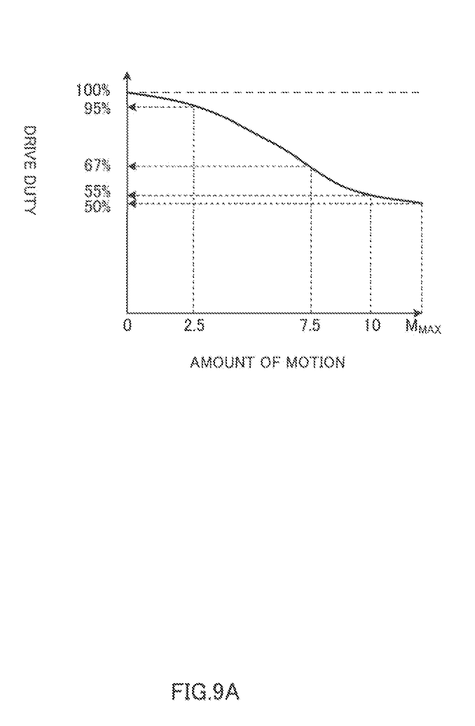

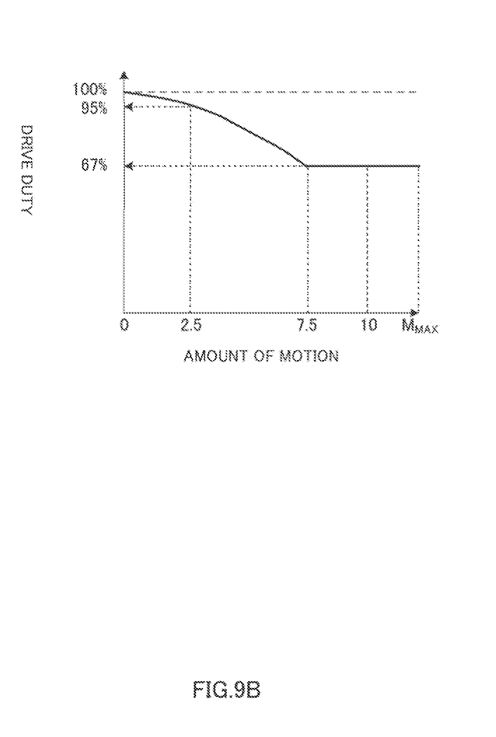

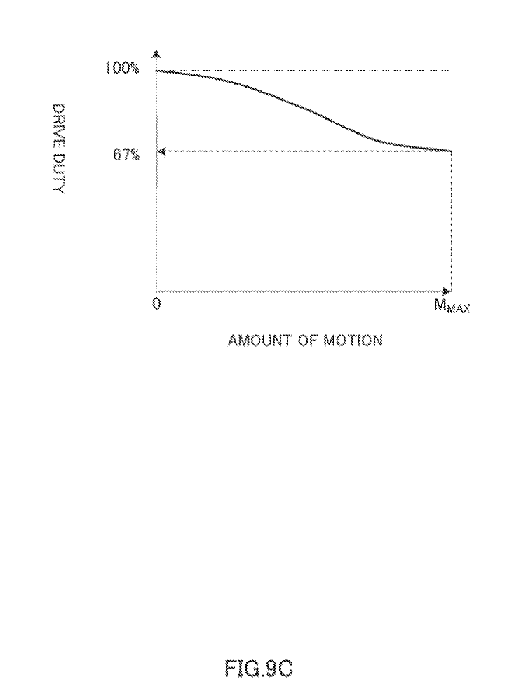

FIG. 9A, FIG. 9B and FIG. 9C show the method of calculating drive duty based on the detected amount of motion, by graphs showing the relationships between the detected amount of motion and drive duty.

FIG. 9A shows an example case where the lower-limit value of duty is set at 50%. In this example, when an amount of motion of zero is detected, the drive duty calculated then is 100%, which is the upper-limit. Furthermore, when an amount of motion to match the maximum value M_{MAX} is detected, the drive duty calculated then is 50%, which is the lower-limit. Also, when an amount of motion between zero and the maximum value M_{MAX} is detected, the drive duty to be calculated becomes gradually lower as the detected amount of motion increases. For example, the drive duty is 95% when the detected amount of motion is 2.5, 67% when the detected amount of motion is 7.5, and 55% when the detected amount of motion is 10.

FIG. 9B shows an example case where the lower-limit value of duty that is set changed from 50% to 67%. In this example, when the detected amount of motion is zero, the drive duty to be calculated then is 100%, which is the upper-limit. Then, when the detected amount of motion is the predetermined maximum value M_{MAX}, the drive duty to be calculated then is 67%, which is the lower-limit. Furthermore, until the detected amount of motion of 7.5, at which the drive duty of 67% is calculated, the drive duty to be calculated decreases gradually as the detected amount of motion increases, following the same changes as in the case of FIG. 9A. Then, when an amount of motion to exceed the amount of motion of 7.5 is detected, the drive duty to be calculated then is fixed at 67%.

Consequently, by providing a configuration for comparing the value obtained by a conversion formula and the lower-limit duty value that is set, and by making this structure to operate to select the lower-limit duty value when the lower-limit duty value is greater, it is possible to realize the calculation method shown in FIG. 9B using the conversion formula in the calculation method shown in FIG. 9A on an as is basis.

FIG. 9C shows another example case where the lower-limit duty value that is set changes from 50% to 67%. In this example, when the detected amount of motion is zero, the drive duty to be calculated then is 100%, which is the upper-limit. Then, when the detected amount of motion is the predetermined maximum value M_{MAX}, the drive duty to be calculated then is 67%, which is the lower-limit. Furthermore, when an amount of motion between zero and the maximum value M_{MAX} is detected, the drive duty to be calculated then gradually decreases with smaller changes than shown in FIG. 9A.

Consequently, the calculation method shown in FIG. 9C cannot be realized by using the conversion formula of the calculation method shown in FIG. 9A as is. For example, process to calculate the coefficient in the equation from the increased lower-limit value of duty is required.

Consequently, regarding the operation when the lower-limit value of duty changes, to compare the calculation methods shown in FIGS. 9B and 9C, the calculation method shown in FIG. 9C requires an operation for deriving a new conversion formula. By contrast with this, the calculation method shown in FIG. 9B only requires processing for changing the threshold for comparison, and therefore is advantageous in terms of processing load.

On the other hand, even when the lower-limit value of duty changes, with the calculation method shown in FIG. 9B, drive duty changes in a light emitting area where the drive duty is originally large (that is, in a light emitting area where the amount of motion is small). By contrast with this, with the calculation method shown in FIG. 9C, the drive duty changes in all light emitting areas. A described later, when the lower-limit value of duty is changed depending on power consumption, with the calculation method shown in FIG. 9C, it is possible to control power in proportion to the lower-limit value of duty. Furthermore, with the calculation method shown in FIG. 9B, cases might occur where drive duty changes only in part of the light emitting areas yet does not change in the surrounding light emitting areas. When drive conditions change locally like this, there is a likelihood of identifying unnecessary flicker between light emitting areas. With the calculation method shown in FIG. 9C, drive conditions change in the whole light emitting area, so that it is possible to reduce the likelihood of identifying unnecessary flicker due to local change of drive conditions.

The specific numerical values shown in FIGS. 9A, 9B and 9C are examples and may be changed variously.

<1-1-3-3. Drive Current Operation Section>

Drive current operation section 134 performs an operation for acquiring the peak value of a drive pulse from drive duty output from drive duty operation section 133. That is to say, drive current operation section 134 determines the peak value in each light emitting area based on the drive duty calculated in each light emitting area.

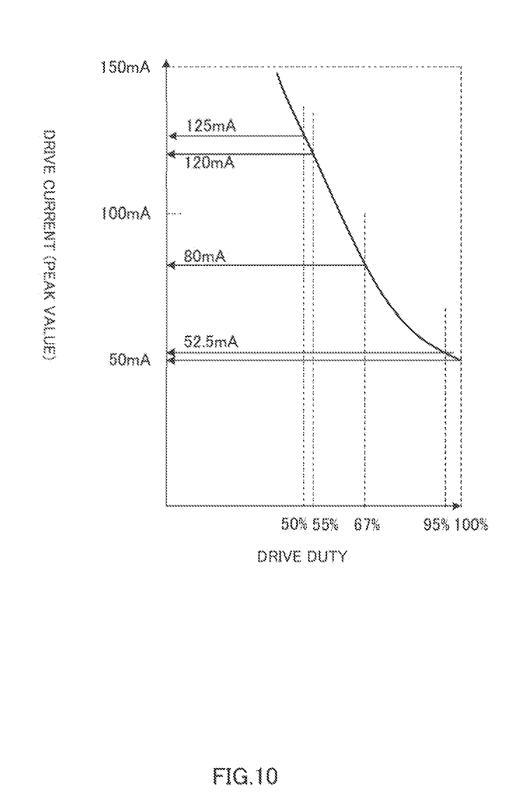

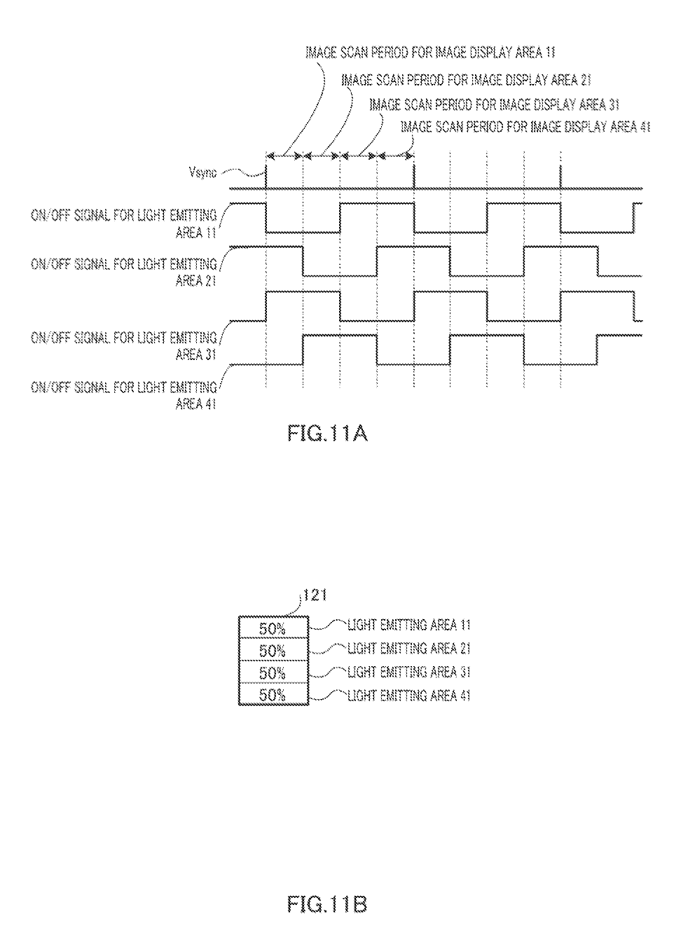

Now, drive current operation section 134 controls the peak values to achieve a predetermined level of brightness regardless of the variation of drive duty values. Consequently, as shown in FIG. 10, for example, drive current operation section 134 has a table showing the relationship between drive duty and peak value to make the brightness a predetermined value, and determines a peak value from drive duty with reference to this table. Note that the amount of motion and drive duty are substantially related such that drive duty decreases when the amount of motion increases, and the specific values in FIG. 10 are given simply by way of example and various changes are possible.

Drive current operation section 134 generates current value data, which is a digital signal to represent the determined peak value, and outputs this to illuminating section 120. By this means, a peak value is designated as a drive condition per light emitting area.

<1-1-3-4. Scan Controller>

Based on the drive duties determined on a per scan area basis, scan controller 135 generates ON/OFF signals on a per scan area basis, at timing based on a vertical synchronization signal, and outputs the generated ON/OFF signals to illuminating section 120. By this means, a drive duty is designated as a drive condition in every scan area. By this means, when an ON/OFF signal for one scan area is an ON signal, above LED driver 123 makes that scan area drive and emit light, or, if that ON/OFF signal is an OFF signal, instead of making that scan area drive and emit light, generates a drive pulse and supplies this drive pulse to LEDs 122 included in that scan area.

FIG. 11A shows examples of ON/OFF signal waveforms output from scan controller 135. Here, ON/OFF signals that are output when, as shown in FIG. 11B, the drive duties determined for four light emitting areas 11, 21, 31 and 41 are all 50% and identical. Image scan is performed in the order of image display area 11, image display area 21, image display area 31 and image display area 41, and backlight scan is also performed in the order of light emitting area 11, light emitting area 21, light emitting area 31 and light emitting area 41.

Also, in the examples shown in FIG. 11A, in the image scan period for image display areas 11, 21, 31 and 41, the timing to turn off corresponding light emitting areas 11, 21, 31 and 41 is controlled, so that it is possible to improve movie resolution.

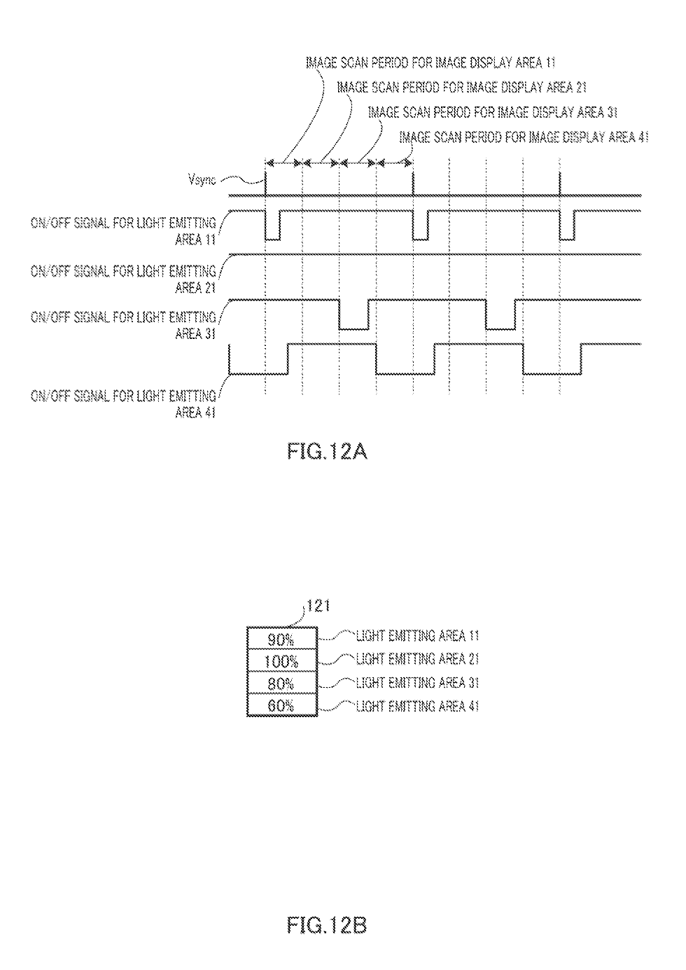

FIG. 12A shows other examples of ON/OFF signal waveforms output from scan controller 135. Here, as shown in FIG. 12B, ON/OFF signals that are output when the drive duties that are determined with respect to four light emitting areas 11, 21, 31 and 41 vary, are shown. As obvious from FIG. 12A, when changing the drive duty of each light emitting area 11, 21, 31 or 41, only the rising phase of the ON/OFF signal of each light emitting area 11, 21, 31 or 41 is changed, without changing the trailing phase.

<1-1-3-5. Power Estimation Section>

Power estimation section 136 performs an operation for estimating the power consumption of light emitting section 121 from the drive duty and peak value determined per light emitting area.

Drive duty and peak value are both determined on a per light emitting area, so that power estimation section 136 estimates power consumption, individually, on a per light emitting area basis. Then, given that a common lower-limit value of duty is set in all light emitting areas, power estimation section 136 calculates the total power consumption of all light emitting areas—that is, the power consumption of light emitting section 121—from the power consumptions estimated per light emitting area.

To be more specific, power consumption Pij of light emitting area ij (i and j are both integers from 1 to 4 according to the present embodiment) can be estimated from following equation 1. Then, power consumption Pa of light emitting section 121 can be obtained by calculating the sum or average value of power consumptions estimated with respect to all light emitting areas. A_{MAX} in equation 1 is the maximum peak value that can be determined, Aij is the peak value determined with respect to light emitting area ij, and Dij is the drive duty determined with respect to light emitting area ij. 100% in equation 1 means that the maximum value of drive duty that can be determined is 100%.

$$\begin{matrix}( Equation 1 ) & \\ Pij = \frac{Aij \times Dij}{{A}_{MAX} \times 100 \%} & [ 1 ]\end{matrix}$$

Taking into account the linear relationship between the peak value and power if the power supply voltage is constant, and the linear relationship between drive duty and power if the drive pulse waveform is rectangular, it is possible to estimate the an indicator to show the magnitude of power consumption in each light emitting area in a simple manner using the above equation.

Here, it is possible to use other methods of estimation, by, for example, estimating the power consumption in each light emitting area in watts, and calculating their total as estimated power consumption of light emitting section 121.

<1-1-3-6. Lower-limit Duty Value Setting Section>

Lower-limit duty value setting section 137 performs an operation for setting the lower-limit duty value, which is the lower-limit value of duty, with respect to each light emitting area, by calculating this lower-limit duty value from the estimated power consumption (estimated power consumption) of light emitting section 121. Lower-limit duty value setting section 137 constitutes a drive condition changing section that changes the range of drive conditions that can be designated.

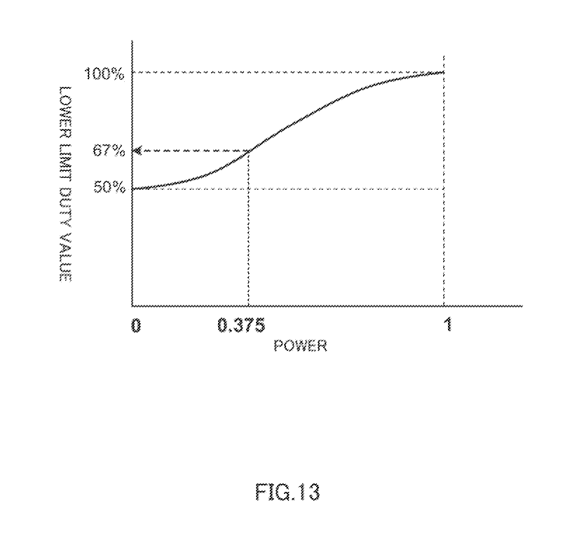

FIG. 13 shows the method of calculating the lower-limit value of duty based on estimated power consumption, by graphs representing the relationship between power and lower-limit duty value. In the example shown in FIG. 13, when estimated power consumption is the minimum value 0, the lower-limit duty value calculated then is 50%, which is the minimum value. The lower-limit value of duty to be calculated gradually decreases as estimated power consumption increases, and, when estimated power consumption is 1 m, which is the maximum value, the lower-limit value to be calculated then is 100%, which is the maximum value. For example, when estimated power consumption is 0.375, the lower-limit duty value to be calculated then is 67%. The numerical values shown in FIG. 13 are only examples and can be changed variously.

The lower-limit duty value, once set, is fed back to drive duty operation section 133, and drive duty operation section 133 calculates drive duty based on this value. Then, drive current operation section 134 determines the peak value depending on the drive duty calculated in drive duty operation section 133.

Consequently, lower-limit duty value setting section 137 sets the lower-limit duty value at 50%, the minimum value of drive duty then calculated by drive duty operation section 133 is 50%. On the other hand, the maximum value of drive duty that can be calculated then by drive duty operation section 133 is 100%. Consequently in this case, the range of drive duty that can be determined in drive duty operation section 133 is 50-100% (FIG. 9A). With the present embodiment, the drive duty determined by drive duty operation section 133 is designated as a drive condition, so that the range of drive duty that can be determined as a drive condition in the event the lower-limit duty value 50% is 50-100%. Furthermore, the range of peak values that can be determined based on the calculation result of drive duty is 50-125 mA (FIG. 10). With the present embodiment, the peak value determined by drive current operation section 134 is designated as a drive condition so that the range of peak values that can be designated as a drive condition when the lower-limit value of duty is 50% is 50 to 125 mA.

Then, when the lower-limit duty value set in lower-limit duty value setting section 137 changes to 67%, the minimum value of drive duty that can be calculated by drive duty operation section 133 changes to 67%. Consequently, the range of drive duty that can be determined in drive duty operation section 133 changes to 67-100% (FIG. 9B or FIG. 9C), and the range of drive duty that can be designated as a drive condition becomes 67-100%. Furthermore, the range of peak values that can be determined depending on the drive duty calculation result changes to 50-80 mA (FIG. 10), and the range of peak values that can be designated as a drive condition changes to 50-80 mA.

By this means, lower-limit duty value setting section 137 changes the designatable range of drive conditions depending on estimated power consumption.

With the present embodiment, the drive duty that is calculated based on the detected amount of motion and the drive duty that is designated as a drive condition are always equal. Consequently, lower-limit duty value setting section 137 is able to change the lower-limit value of drive duty, which can be calculated based on the detected amount of motion, depending on estimated power consumption, and therefore is able to change the range of drive duty that can be designated depending on estimated power consumption.

With the present embodiment, a peak value is determined based on a result of calculating drive duty based on a detected amount of motion. Consequently, lower-limit duty value setting section 137 does not actively set the value for limiting the range that can be designated with respect to peak values. Instead, lower-limit duty value setting section 137 is able to change the range of peak values that can be designated, based on estimated power consumption, by setting the lower-limit value of drive duty that is calculated based on the detected amount of motion, depending on estimated power consumption.

That is to say, with the present embodiment, for both drive duty and peak value that are included in drive conditions, it is possible to change the designatable range based on estimated power consumption.

Furthermore, lower-limit duty value setting section 137 sets only the lower-limit value, without setting the upper-limit value, with respect to drive duty. If drive duty lowers significantly, the peak value increases significantly in response to this, and cases might occur where this causes the lowering of efficiency of light emission and significant increase of power consumption in light emitting section 121. Consequently, it is possible to reduce the increase of power consumption in light emitting section 121 by setting the lower-limit value of drive duty alone.

Consequently, lower-limit duty value setting section 137 sets a higher lower-limit duty value when greater power consumption is estimated. Consequently, when lower power consumption is estimated, a lower-limit duty value is set. Consequently, under the circumstance where video blur is prone to occur such as when the amount of motion in an image is large, it is possible to improve image blur by reducing the drive duty, based on need, based on a detection result of the amount of motion.

The configuration of liquid crystal display apparatus 100 has been described.

<1-2. Operation of Liquid Crystal Display Apparatus>

Next, operations to be executed by liquid crystal display apparatus 100 as a whole (that is, overall operations), and especially the characteristic operations of the present invention, will be described.

<1-2-1. Overall Operations>

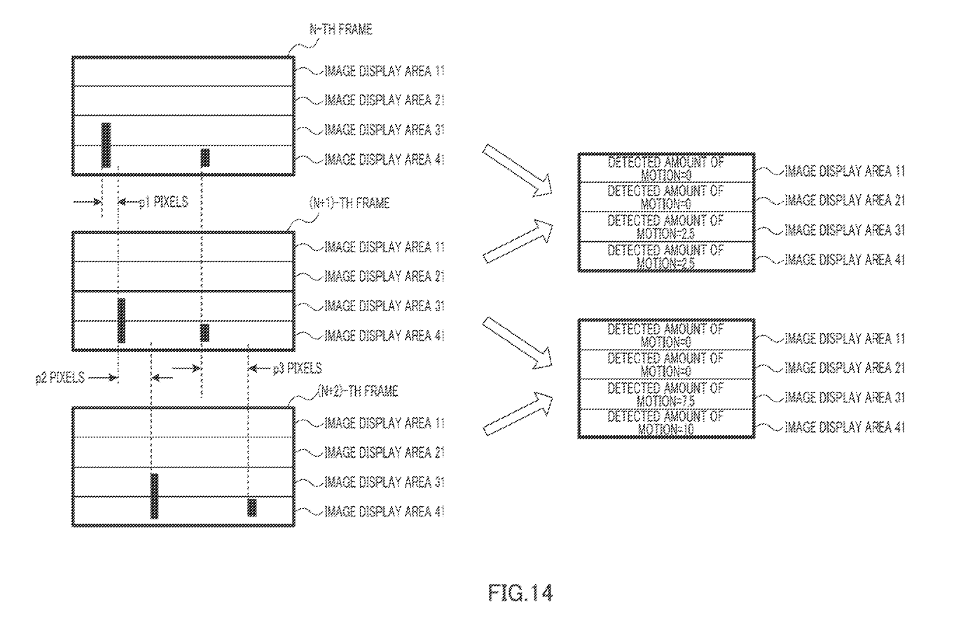

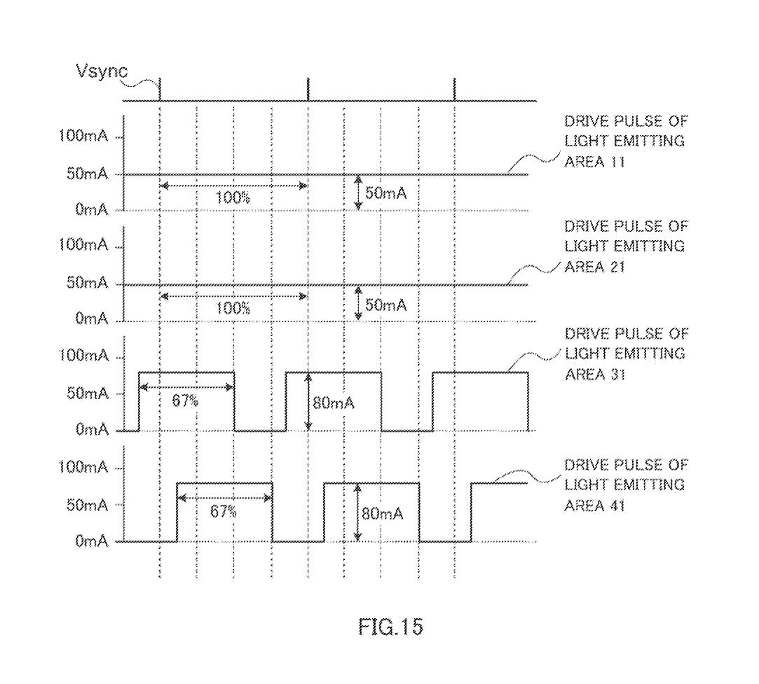

Examples of overall operations will be described using FIG. 14 and FIG. 15.

FIG. 14 shows a motion amount detection operation with respect to a series of image signals received as input in liquid crystal panel section 110. Here, a movie is used as an example in which a pair of black vertical lines on a white background move laterally (hereinafter the longer one will be referred to as “long line” and the shorter one will be referred to as “short line”). For ease of explanation, only partial images in image display areas 11, 21, 31 and 41 will be described.

In this example, from the N-th frame to the (N+1)-th frame, the long line moves p1 pixels, and the amount of motion 2.5 is detected in each of image display areas 31 and 41. Consequently, from the (N+1)-th frame to the (N+2)-th frame, the long line moves p2 pixels and the short line moves p3 pixels, so that the amount of motion 7.5 is detected in image display area 31 and the amount of motion 10 is detected in image display area 41.

Here, this example assumes that the power consumption 0.375 is estimated with respect to light emitting section 121, from the drive duties and peak values determined with respect to individual light emitting areas upon displaying the image of the (N+1)-th frame.

For example, with reference to FIG. 13, lower-limit duty value setting section 137 calculates the lower-limit duty value of 67% following the relationship between power and lower-limit duty value. Thus, the lower-limit duty value calculated from the drive conditions determined with respect to the (N+1)-th frame, is used upon determining the drive conditions for the (N+2)-th frame, as will be explained later.

Drive duty operation section 133 calculates drive duty based on the detected amount of motion, so as not to fall below the lower-limit duty value 67%, as shown in FIG. 9B. For example, the drive duty calculated with respect to the detected amount of motion 0 is 100%, and the drive duty calculated with respect to the detected amounts of motion 7.5 and 10 is 67%.

Then, drive current operation section 134 determines a peak value, based on the calculation result of drive duty, according to the relationship between drive duty and peak value shown in FIG. 10, for example. For example, the peak value determined in response to the drive duty 100% is 50 mA and the peak value determined in response to the drive duty 67% is 80 mA.

In the example shown in FIG. 14, with respect to the (N+2)-th frame, the amount of motion detected in image display areas 11 and 21 is 0, the amount of motion detected in image display area 31 is 7.5, and the amount of motion detected in image display area 41 is 10.

Consequently, upon displaying the image of the (N+2)-th frame, as shown in FIG. 15, the drive duty 100% and peak value of 50 mA are designated with respect to light emitting areas 11 and 21 corresponding to image display areas 11 and 21. Regarding light emitting area 31 corresponding to image display area 31, a drive duty of 67% and peak value 80 mA are designated, and, for image display area 41 corresponding to image display area 41, a drive duty of 67% and peak value of 80 mA are designated.

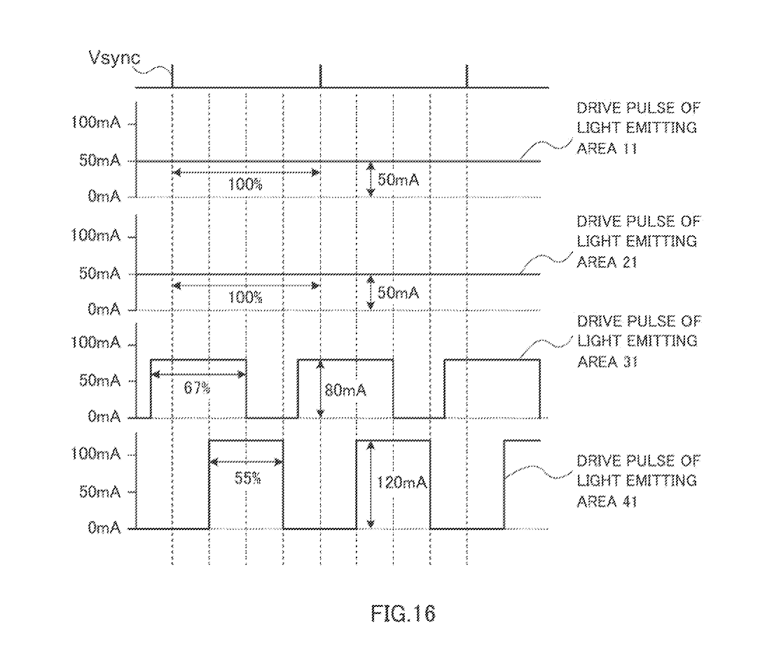

Consequently, in the example of FIG. 14, if the lower-limit duty value is not set on a variable basis, the range of drive duty that can be calculated increases to 50-100%, and the range of peak values that can be determined increases to 50-125 mA (FIG. 9A and FIG. 10). Then, as shown in FIG. 16, with image display area 41 where the detected amount of motion is 10, the drive duty decreases to 55% and meanwhile the peak value increases to 120 mA.

As for the range that can be designated with respect to drive conditions, comparing between a case of making the range variable as in FIG. 15 and a case of making the range not variable as in FIG. 16, the power consumption estimated with respect to light emitting area 41 is greater in the non-variable case of FIG. 16 (80 mAx67%<120 mAx55%). Regarding FIG. 15 and FIG. 16, difference in power consumption is produced only in light emitting area 41. However, when such difference is observed in a greater number of light emitting areas; the power consumption of light emitting area 121 increases more distinctly.

Consequently, the range of drive conditions that can be designated is changed based on change of estimated power consumption with respect to light emitting area 121. By this means, it is possible to reduce the increase of the maximum power consumption of a backlight apparatus including light emitting section 121.

### Embodiment 2

Embodiment 2 of the present invention will be described below. The liquid crystal display apparatus of the present embodiment has the same basic configuration as the liquid crystal display apparatus of the earlier embodiment. Consequently, parts that are the same as in the earlier embodiment or parts that are equivalent to the earlier embodiment will be assigned the same reference numerals without further explanations, and the differences will be mainly explained.

A case will be described with the present embodiment where a light adjustment value calculation result is reflected in estimation of power consumption, and, based on this estimation result, a lower-limit duty value is set on a variable basis.

<2-1. Configuration of Liquid Crystal Display Apparatus>

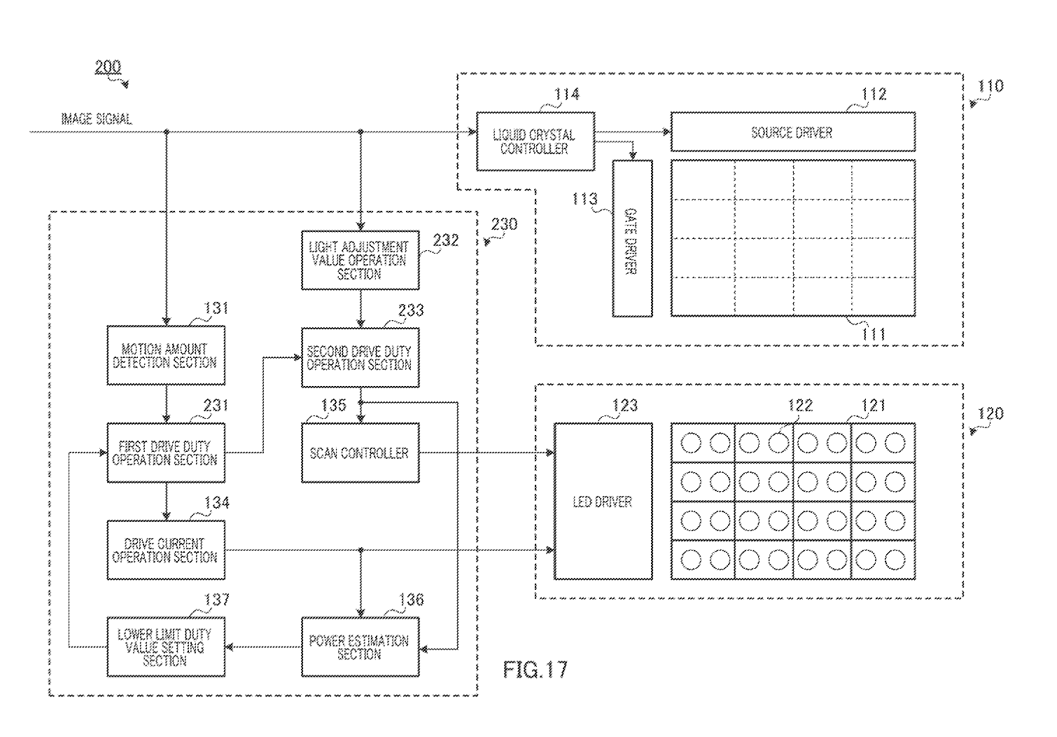

FIG. 17 shows a configuration of the liquid crystal display apparatus of the present embodiment. Liquid crystal display apparatus 200 has drive control section 230 instead of drive control section 130. Drive control section 230 is an operation processing apparatus having motion amount detection section 131, first drive duty operation section 231, light adjustment value operation section 232, second drive duty operation section 233, drive current operation section 134, scan controller 135, power estimation section 136 and lower-limit duty value setting section 137, and controls drive conditions including drive pulse duty and peak value on a per light emitting area basis based on an input image signal of each image display area. First drive duty operation section 231, second drive duty operation section 233, drive current operation section 134 and scan controller 135, combined, constitute a drive condition designating section that designates drive conditions on a per light emitting area basis.

<2-1-1. First Drive Duty Operation Section>

First drive duty operation section 231 is basically the same as drive duty operation section 133 of embodiment 1. In particular, the points of calculating drive duty based on a lower-limit duty value set in lower-limit duty value setting section 137 and outputting the calculated drive duty to drive current operation section 134, are the same. However, there is a difference of outputting the calculated drive duty to second drive duty operation section 233, not scan controller 135.

That is to say, the drive duty that is calculated by first drive duty operation section 231 serves as the base of peak values determined by drive current operation section 134, do not serve as drive duty to be designated as a drive condition. Second drive duty operation section 233 (which will be described later) determines the drive duty to be designated.

<2-1-2. Light Adjustment Value Operation Section>

Light adjustment value operation section 232 performs an operation to calculate the light adjustment value for each light emitting area based on image signals. According to this operation, light adjustment value operation section 232 calculates a greater light adjustment value when an image represented by an image signal is brighter.

The calculation of light adjustment values based on image signals may be controlled over a full screen or may be controlled on a per area basis. That is to say, in the event of full-screen control, the same light adjustment value is obtained between individual light emitting areas, and, in the event of control on a per area basis, it is possible to calculate different light adjustment values between light emitting areas. In the event of the control per area, the drive duty calculated with respect to a given light emitting area and the light adjustment value calculated with respect to that light emitting areas, are multiplied mutually.

<2-1-3. Second Drive Duty Operation Section>

Second drive duty operation section 233 determines a drive duty to designate as a drive condition based on the drive duty calculated by first drive duty operation section 231 and the light adjustment value calculated by light adjustment value operation section 232.

To be more specific, second drive duty operation section 233 determines, as a drive duty to designate, the product of the drive duty calculated by first drive duty operation section 231 and the light adjustment value calculated by light adjustment value operation section 232.

<2-1-4. Lower-Limit Duty Value Setting Section>

Lower-limit duty value setting section 137 is different from lower-limit duty value setting section 137 of embodiment 1, as will be explained below.

When a lower-limit duty value is set based on estimated power consumption, the lower-limit duty value is fed back to first drive duty operation section 231, and first drive duty operation section 231 calculates drive duty based on this value. For example, when the lower-limit duty value is set to 67% by lower-limit duty value setting section 137, the minimum value of drive value that can be calculated by first drive duty operation section 231 is 67%.

With the present embodiment, even when the drive duty calculated by first drive duty operation section 231 is 67%, which matches the lower-limit duty value that is set, this is not necessarily the minimum value in the range that can be designated with respect to drive duty. With the present embodiment, the adjustment light value calculated by light adjustment value operation section 232 falls below 100%, it is possible to make the drive duty to be actually designated as a drive condition lower than 67%.

Consequently, there are cases where lower-limit duty value setting section 137 of the present embodiment is unable to change the range of drive duty, which can be designated with respect to drive duty, according to changes of estimated power consumption.

In other words, with the present embodiment, although the lower-limit duty value based on an estimation result of power consumption increases, it is possible to decrease the actual drive duty based on the decrease.

By the way, peak value is determined based on drive duty calculated by first drive duty operation section 231. Consequently, when the lower-limit duty value that is set increases, for example, to 67%, and the drive duty that can be calculated by first drive duty operation section 231 increases to 67%, in response to this, the peak value to be determined by drive current operation section 134 decreases to 80 mA.

Consequently, similar to embodiment 1, lower-limit duty value setting section 137 of the present embodiment is able to change the range of peak values that cane be designated as a drive condition based on change of estimated power consumption.

In this way, according to the present embodiment, it is possible to change the designatable range of drive conditions based on change of estimated power consumption with respect to light emitting section 121. Consequently, it is possible to reduce the increase of the maximum power consumption of a backlight apparatus including light emitting section 121.

### Embodiment 3

Embodiment 3 of the present invention will be described now. The liquid crystal display apparatus of the present embodiment has the same basic configuration as the liquid crystal display apparatus of the earlier embodiment. Consequently, parts that are the same as in the earlier embodiment or parts that are equivalent to the earlier embodiment will be assigned the same reference numerals without further explanations, and the differences will be mainly explained.

A case will be described with the present embodiment where power consumption is estimated from a calculation result of a light adjustment value and a lower-limit value of drive duty is set on a variable basis based on that estimation result.

<3-1. Configuration of Liquid Crystal Display Apparatus>

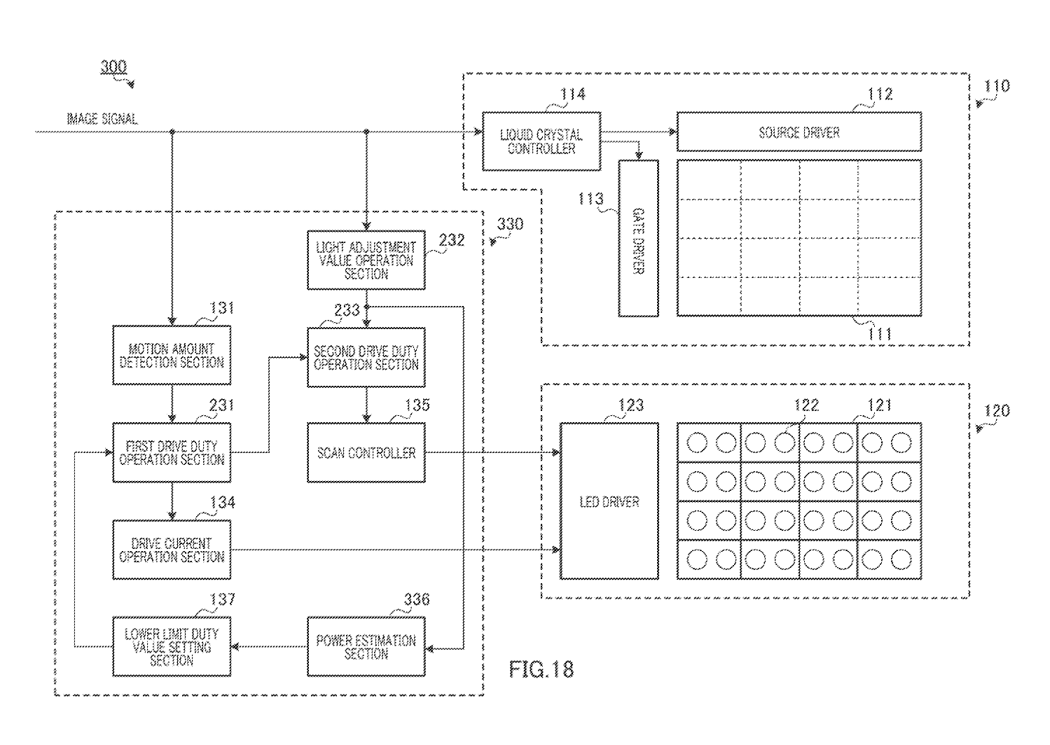

FIG. 18 shows a configuration of a liquid crystal display apparatus according to the present embodiment. Liquid crystal display apparatus 300 has drive control section 330 instead of drive control section 130. Drive control section 330 is an operation processing apparatus having motion amount detection section 131, first drive duty operation section 231, light adjustment value operation section 232, second drive duty operation section 233, drive current operation section 134, scan controller 135, power estimation section 336 and lower-limit duty value 137, and controls drive conditions including drive pulse duties and peak values on a per scan area basis based on an input image signal of each image display area.

<3-1-1. Power Estimation Section>

Power estimation section 336 performs an operation for estimating power consumption from a calculation result of a light adjustment value. The lower-limit duty value is set in common in all light emitting areas, so that power estimation section 336 estimates the total power consumption of all light emitting areas—that is, the power consumption of light emitting section 121.

In this operation, power estimation section 336 ignores change of light emission rate of due to change in light emitting values, estimates the power consumption based on the light adjustment value calculated from an image signal.

To be more specific, power estimation section 336 acquires the light adjustment value of each light emitting area calculated by light adjustment value operation section 232. Then, power estimation section 336 acquires an average light adjustment value by calculating an average of the acquired light adjustment values, and estimates this as the power consumption of light emitting section 121.

By this means, with the present embodiment, power consumption is estimated based solely on light adjustment value, so that it is possible to estimate power consumption in a more simple manner.

### Embodiment 4

Embodiment 4 of the present invention will be described below. The liquid crystal display apparatus of the present embodiment has the same basic configuration as the liquid crystal display apparatus of the earlier embodiment. Consequently, parts that are the same as in the earlier embodiment or parts that are equivalent to the earlier embodiment will be assigned the same reference numerals without further explanations, and the differences will be mainly explained.

A case will be described with the present embodiment where power consumption estimated from a light adjustment value calculation result is corrected based on a determined peak value, and, based on the corrected estimation result, the lower-limit value of drive duty is set on a variable basis.

<4-1. Configuration of Liquid Crystal Display Apparatus>

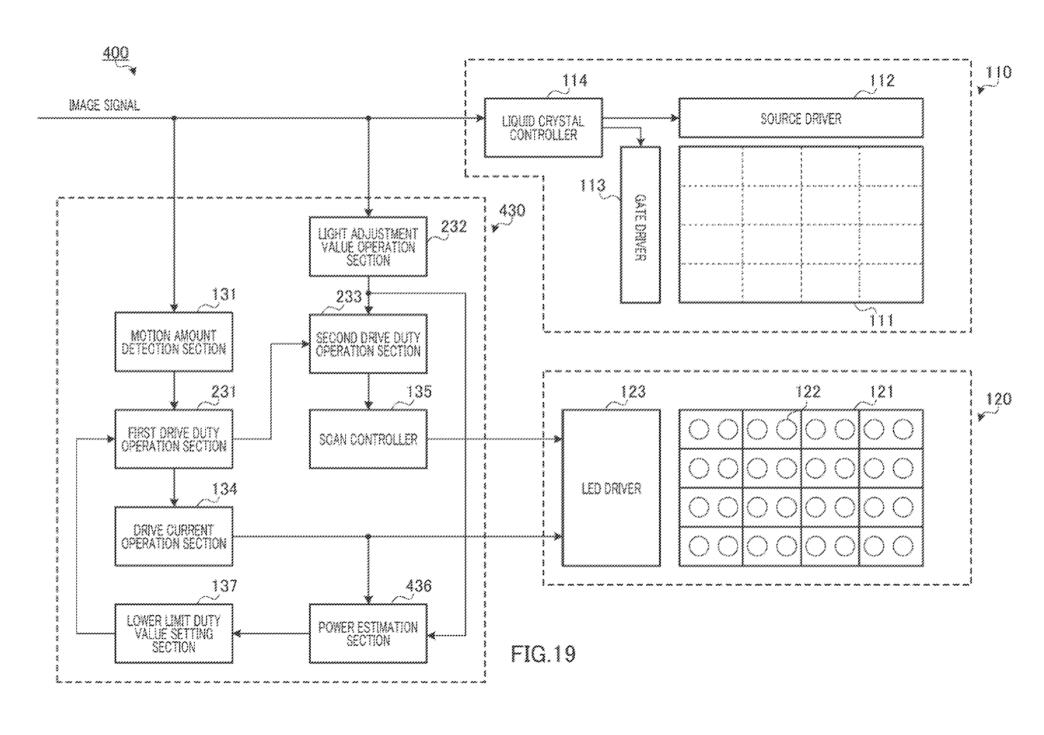

FIG. 19 shows a configuration of the liquid crystal display apparatus of the present embodiment. Liquid crystal display apparatus 400 has drive control section 430 instead of drive control section 130. Drive control section 430 is an operation processing apparatus having motion amount detection section 131, first drive duty operation section 231, light adjustment value operation section 232, second drive duty operation section 233, drive current operation section 134, scan controller 135, power estimation section 436 and lower-limit duty value setting section 137, and controls drive conditions including drive pulse duty and peak value on a per light emitting area basis based on an input image signal of each image display area.

<4-1-1. Power Estimation Section>

Power estimation section 436 performs an operation for estimating power consumption from a calculation result of light adjustment value. The lower-limit duty value is set in common in all light emitting areas, so that power estimation section 436 estimates the total power consumption of all light emitting areas—that is, the power consumption of light emitting section 121.

In this operation, power estimation section 436 estimates the power consumption of light emitting section 121 taking into account change of light emission rate due to change of peak value.

To be more specific, power estimation section 436 acquires a light adjustment value in each light emitting area calculated in light adjustment value operation section 232, and estimates the acquired light adjustment value as the power consumption of each light emitting area. Then, power estimation section 436 calculates an average of the light adjustment values of all light emitting areas (that is, an average light adjustment value), and estimates the average light adjustment value as the power consumption of light emitting section 121.

Furthermore, power estimation section 436 acquires the peak value of each light emitting area determined by drive current operation section 134, and calculates an average of the peak values (that is, an average peak value) of all light emitting areas.

Then, power estimation section 436 corrects the power consumption of light emitting section 121 by multiplying the power consumption of light emitting section 121 estimated as above, by a correction coefficient to match the average peak value. The corrected, estimated power consumption acquired this way is output to lower-limit duty value setting section 137 and used to set the lower-limit value of duty on a variable basis.

By this means, with the present embodiment, the power consumption of light emitting section 121 is corrected based on a determined peak value. Consequently, it is possible to estimate power consumption taking into account changes of light emission rate due to change of peak value, and, maintain the accuracy of estimation to a certain level by simple estimation of power consumption.

### Variation of Embodiment 4

In the above configuration 4, power estimation section 436 might correct power consumption before calculating estimated power consumption of light emitting section 121. Specific descriptions will be described below.

Power estimation section 436 acquires the light adjustment value of each light emitting area calculated in light adjustment value operation section 232, and estimates these acquired light adjustment values as the power consumption in each light emitting area.

Moreover, power estimation section 436 acquires the peak value of each light emitting area (that is, individual peak value) determined by drive current operation section 134.

Then, power estimation section 436 corrects the power consumption of each light emitting area by multiplying the power consumption of each light emitting area estimated as above, by a correction coefficient to match each individual peak value. Here, the power consumption in a given light emitting area is multiplied by a correction coefficient to match the peak value of that light emitting area.

Then, power estimation section 436 calculates an average of power consumption of individual light emitting areas after correction as the estimated power consumption of light emitting section 121. The estimated power consumption of light emitting section acquired this way is output to lower-limit duty value setting section 137 and used to set the lower-limit duty value on a variable basis.

By this means, it is possible to improve the accuracy of estimation of simple power consumption estimation.

### Embodiment 5

Embodiment 5 of the present invention will be described in detail. The liquid crystal display apparatus of the present embodiment has the same basic configuration as the liquid crystal display apparatus of the earlier embodiment. Consequently, parts that are the same as in the earlier embodiment or parts that are equivalent to the earlier embodiment will be assigned the same reference numerals without further explanations, and the differences will be mainly explained.

A case will be described with the present embodiment where power consumption estimated from a calculation result of a light adjustment value is corrected based on the amount of motion detected in an image, and, based on the estimation result after correction, sets the lower-limit value of drive duty based on the corrected, estimation result.

<5-1. Configuration of Liquid Crystal Display Apparatus>

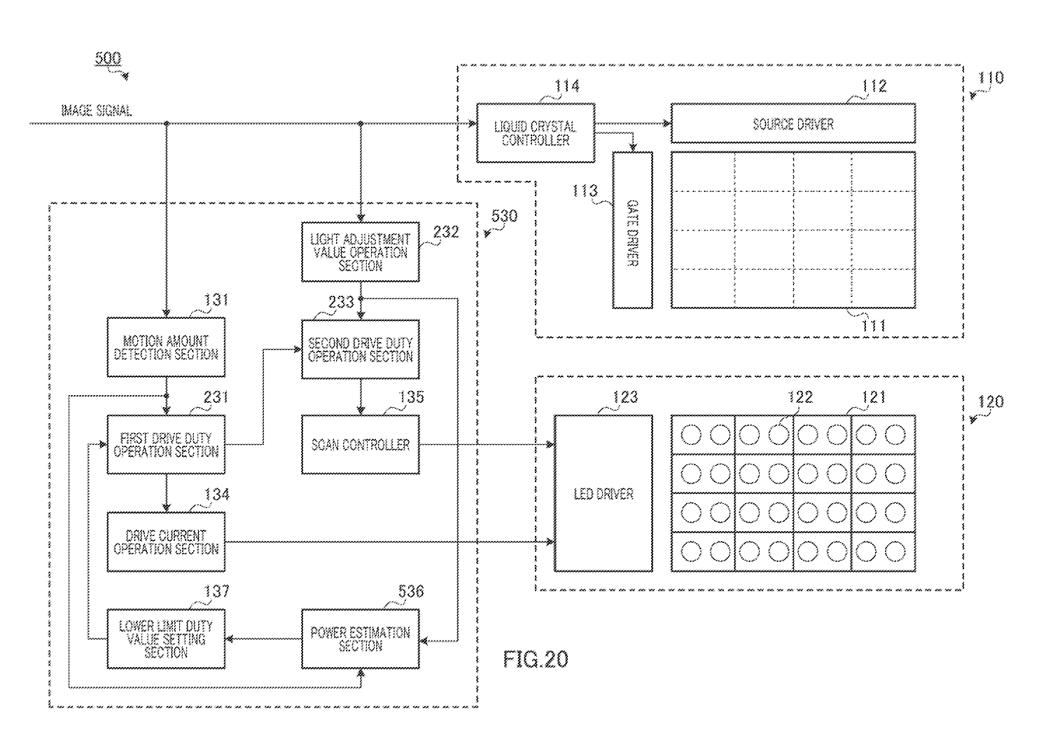

FIG. 20 shows a configuration of a liquid crystal display apparatus according to the present embodiment. Liquid crystal display apparatus 500 has drive control section 530 instead of drive control section 130. Drive control section 530 is an operation processing apparatus having motion amount detection section 131, first drive duty operation section 231, light adjustment value operation section 232, second drive duty operation section 233, drive current operation section 134, scan controller 135, power estimation section 536 and lower-limit duty value setting section 137, and controls drive conditions including drive pulse duty and peak value on a per light emitting area basis based on an input image signal per light emitting area based on an input image signal of each image display area.

<5-1-1. Power Estimation Section>

Power estimation section 536 performs an operation for estimating power consumption from a calculation result of a light adjustment value. When the lower-limit duty value is set in common between all light emitting areas, power estimation section 536 estimates the total power consumption of all light emitting areas—that is, the power consumption of light emitting section 121.

According to this operation, power estimation section 536 estimates the power consumption of light emitting section 121 taking into account change in light emission rate due to change of peak values. In this regard, power estimation section 536 is the same as power estimation section 436 of embodiment 4. However, since change of the peak value is caused by change in the amount of motion in an image, power estimation section 536 uses the amount of motion in an image to estimate the power consumption of light emitting section 121.

To be more specific, power estimation section 536 acquires a light adjustment value in each light emitting area calculated in light adjustment value operation section 232, and estimates the acquired light adjustment value as the power consumption of each light emitting area. Then, power estimation section 536 calculates an average of the light adjustment values of all light emitting areas (that is, an average light adjustment value), and estimates the average light adjustment value as the power consumption of light emitting section 121.

Furthermore, power estimation section 536 acquires the amount of motion of each image display area output from motion amount detection section 131, and calculates an average of the amounts of motion of all image display areas (that is, average amount of motion).

Then, power estimation section 536 corrects the power consumption of light emitting section 121, by multiplying the power consumption of light emitting section 121 estimated as described above, by a correction coefficient to match the average amount of motion. The estimated power consumption acquired this way is output to lower-limit duty value setting section 137 and used to set the lower-limit duty value on a variable basis.

By this means, with the present embodiment, the estimated power consumption of light emitting section 121 is corrected based on a detected amount of motion. Consequently, it is possible to estimate power consumption taking into account changes of light emission rate due to change of peak value, and, maintain the accuracy of estimation to a certain level by simple estimation of power consumption.

### Variation of Embodiment 5

Given the above configuration of embodiment 5, power estimation section 536 may estimate power consumption before calculating estimated power consumption of light emitting section 121. Specific explanations will be provided below.

Power estimation section 536 acquires the light adjustment value of each light emitting area calculated by light adjustment value operation section 232, and estimates the acquired light adjustment values as the power consumption of each light emitting area.

Moreover, power estimation section 536 acquires the amount of motion in each image display area output from motion amount detection section 131 (that is, individual amount of motion).

Then, power estimation section 536 corrects the power consumption of each light emitting area by multiplying the power consumption of each light emitting area estimated as above, by a correction coefficient to match each individual amount of motion. Here, the power consumption in a given light emitting area is multiplied by a correction coefficient to match the amount of motion in that light emitting area.

Then, power estimation section 536 calculates an average of power consumption of individual light emitting areas after correction, as the estimated power consumption of light emitting section 121. The estimated power consumption of light emitting section 121 acquired this way is output to lower-limit duty value setting section 137 and used to set the lower-limit duty value on a variable basis.

By this means, it is possible to improve the accuracy of estimation of simple power consumption estimation.

### Embodiment 6

Embodiment 6 of the present invention will be described below. The liquid crystal display apparatus of the present embodiment has the same basic configuration as the liquid crystal display apparatus of the earlier embodiment. Consequently, parts that are the same as in the earlier embodiment or parts that are equivalent to the earlier embodiment will be assigned the same reference numerals without further explanations, and the differences will be mainly explained.

A case will be described with the present embodiment where a light adjustment value calculation result is reflected in estimation of power consumption and based on that estimation result the upper-limit value of peak value is set on a variable basis.

<6-1. Configuration of Liquid Crystal Display Apparatus>

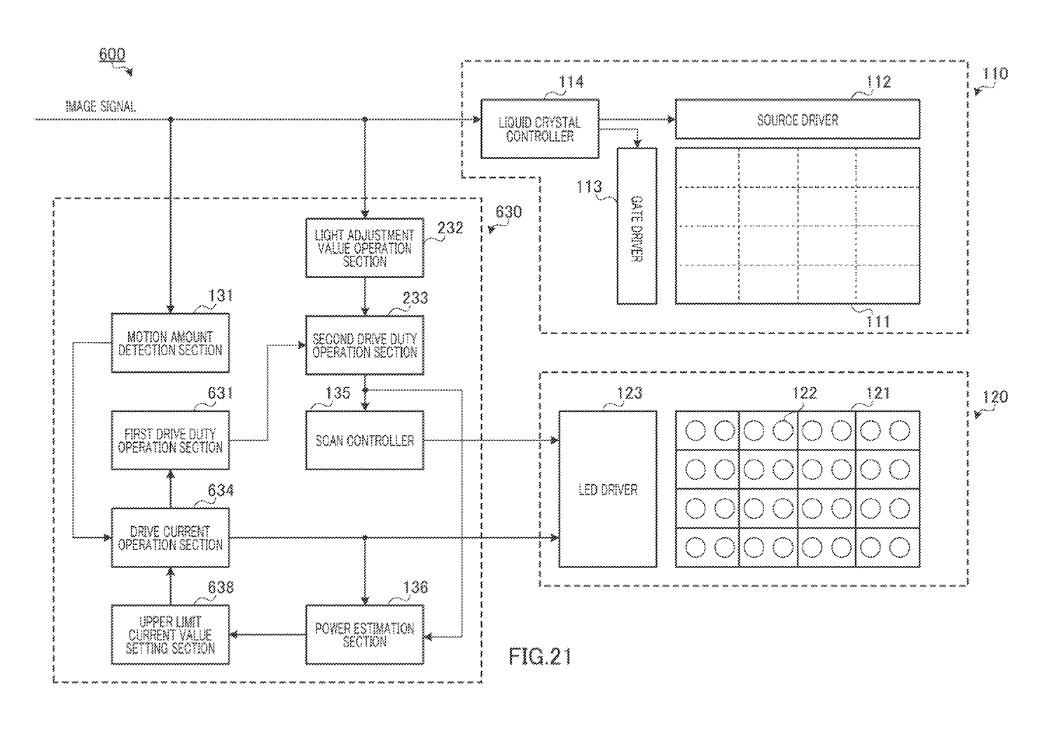

FIG. 21 shows a configuration of a liquid crystal display apparatus according to the present embodiment. Liquid crystal display apparatus 600 has drive control section 630 instead of drive control section 130. Drive control section 630 is an operation processing apparatus having motion amount detection section 131, first drive duty operation section 631, light adjustment value operation section 232, second drive duty operation section 233, drive current operation section 634, scan controller 135, power estimation section 136 and upper-limit current value setting section 638, and controls drive conditions including drive pulse duty and peak value on a per light emitting area basis based on an input image signal per light emitting area based on an input image signal of each image display area. First drive duty operation section 631, second drive duty operation section 233, drive current operation section 634 and scan controller 135, combined, constitute a drive condition designating section that designates drive conditions on a per light emitting area basis.

<6-1-1. Drive Current Operation Section>

Drive current operation section 634 performs an operation for converting the amount of motion of each image display area, which is detected in and output from motion amount detection section 131, into a peak value for each light emitting area.

For the method of finding a peak value from the amount of motion, the method to utilize the relationship between the amount of motion and peak value derived from the relationship shown in FIG. 9A and FIG. 10 is an example. The amounts of motion and peak values are related such that a peak value to be determined increases gradually as the detected amount of motion increases.

Moreover, drive current operation section 634 determines the peak value based on the amount of motion, according to the upper-limit current value fed back from upper-limit current value setting section 638, so as not to exceed the upper-limit current value.

Drive current operation section 634 generates current value data, which is a digital signal to represent the determined peak value, and outputs this to illuminating section 120. By this means, peak values are designated as a drive condition on a per light emitting area basis.

<6-1-2. First Drive Duty Operation Section>

First drive duty operation section 631 performs an operation for converting a peak value determined in drive current operation section 634, into a drive pulse duty value for each light emitting area. First drive duty operation section 631 calculates drive duty per light emitting area, based on the peak value determined per light emitting area. In this operation, the relationship between peak values and drive duty shown in FIG. 10 can be utilized.

<6-1-3. Upper-Limit Current Value Setting Section>

Upper-limit current value setting section 638 performs an operation of calculating and setting the upper-limit current value, which is the upper-limit value of the peak values of individual light emitting areas, from estimated power consumption of light emitting section 121. Upper-limit current value setting section 638 constitutes a drive condition changing section that changes the designatable range of drive conditions.

Upper-limit current value setting section 638 sets the upper-limit current value on a variable basis based on estimated power consumption of light emitting section 121. Estimated power consumption and upper-limit current value are related such the upper-limit current value to be calculated decreases gradually as estimated power consumption increases.

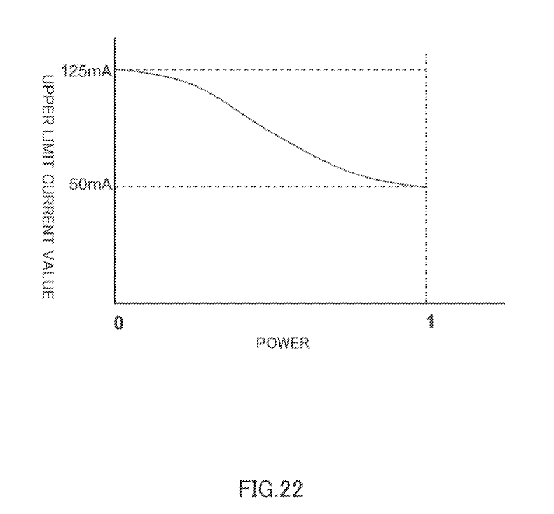

FIG. 22 shows a method of calculating upper-limit current value based on estimated power consumption, by graphs to show the relationship between power and upper-limit current value. In the example shown in FIG. 22, when estimated power consumption is the minimum value 0, the upper-limit current value calculated then is 125 mA, which is the maximum value. The upper-limit current value to be calculated decreases gradually as estimated power consumption increases, and when estimated power consumption is 1 m which is the maximum value, the upper-limit current value calculated then is 50 mA, which is the minimum value. The specific numerical values shown in FIG. 22 are only examples and can be changed variously.

The upper-limit current value, once set, is fed back to drive current operation section 634. Drive current operation section 634 determines the peak value to designate as a drive condition, based on the detected amount of motion, so as not to exceed the fed-back value.

Consequently, upper-limit current value setting section 638 is able to change the range of peak values that can be designated, according to estimated power consumption, by setting the upper-limit value of peak value that can be determined based on the detected amount of motion, on a variable basis, based on estimated power consumption.

Upper-limit current value setting section 638 sets the upper-limit value alone for the peak value, without setting the lower-limit value. There are cases where the peak value increases significantly and where in turn the light emission rate of LED 122 decreases significantly or the power consumption of light emitting section 121 increases significantly. Consequently, it is possible to reduce the increase of power consumption in light emitting section 121 by setting the upper-limit value of peak value alone.

Furthermore, upper-limit current value setting section 638 sets a lower upper-limit current value when greater power consumption is estimated. Consequently, when estimated power consumption is lower, a higher upper-limit current value is set. Consequently, it becomes possible to increase the peak value and in accordance with this decrease drive duty. Consequently, under the circumstance where video blur is prone to occur such as when the amount of motion in an image is large, it is possible to improve image blur by reducing the drive duty, based on need, based on a detection result of the amount of motion.

### Embodiment 7

Embodiment 7 of the present invention will be described now. The liquid crystal display apparatus of the present embodiment has the same basic configuration as the liquid crystal display apparatus of the earlier embodiment. Consequently, parts that are the same as in the earlier embodiment or parts that are equivalent to the earlier embodiment will be assigned the same reference numerals without further explanations, and the differences will be mainly explained.

A case will be described with the present embodiment where an upper-limit value of the amount of motion in an image, which serves as the basis of calculation of drive duty, is set on a variable basis according to estimated power consumption.

<7-1. Configuration of Liquid Crystal Display Apparatus>

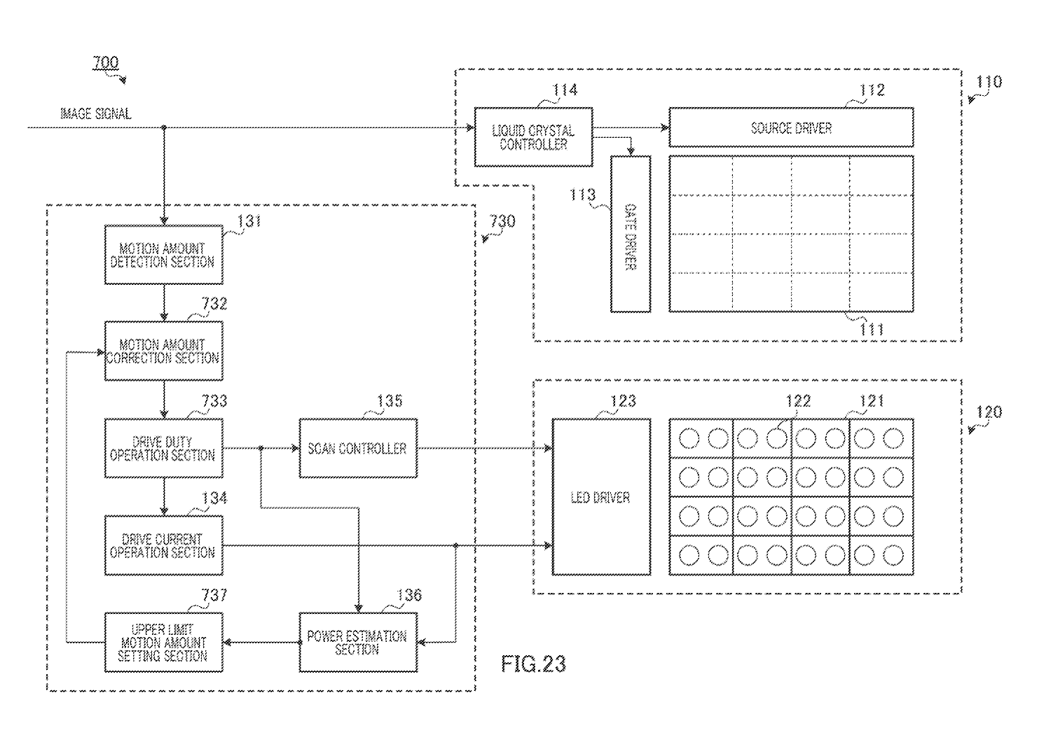

FIG. 23 shows a configuration of a liquid crystal display apparatus according to the present embodiment. Liquid crystal display apparatus 700 has drive control section 730 instead of drive control section 130. Drive control section 730 is an operation processing apparatus having motion amount detection section 131, motion amount correction section 732, drive duty operation section 733, drive current operation section 134, scan controller 135, power estimation section 136 and upper-limit motion amount setting section 737, and controls drive conditions including the duties and peak values of drive pulses on a per light emitting area basis based on an input image signal in each image display area. Drive duty operation section 733, drive current operation section 134 and scan controller 135, combined, constitute a drive condition designating section that designates drive conditions per light emitting area.

<7-1-1. Motion Amount Correction Section>

Motion amount correction section 732 performs an operation for correcting the amount of motion detected per image display area output from motion amount detection section 131 (the amount of motion before correction).

Motion amount correction section 732 corrects the amount of motion before correction, detected per image display area (that is, corrected amount of motion), to output to drive duty operation section 733, so as not to exceed the upper-limit value, according to the upper-limit motion amount value set by upper-limit motion amount value setting section 737.

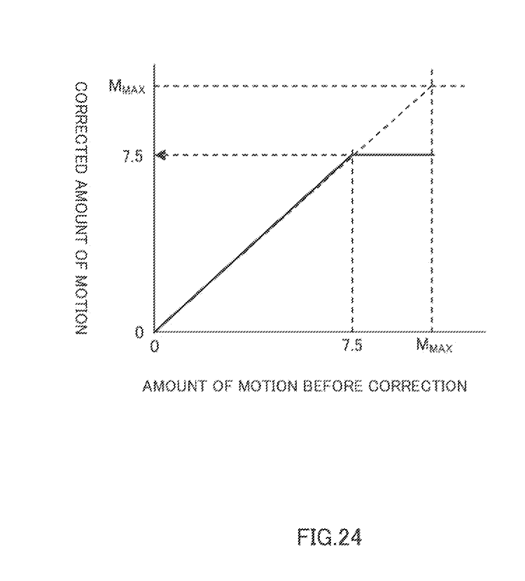

Assuming that the upper-limit of the amount of motion is set to 7.5, as shown in FIG. 24, motion amount correction section 732 outputs the same value as the amount of value before correction, as the corrected amount of motion, when the amount of motion before correction is 7.5 or less, or outputs 7.5 as the corrected amount of motion singularly if the amount of motion before correction exceeds 7.5. Consequently, in this case, even if the amount of motion before correction is M_{MAX}, the corrected amount of motion is 7.5, not M_{MAX}.

<7-1-2. Drive Duty Operation Section>

Drive duty operation section 733 performs an operation for converting an amount of motion, which is detected in and output from motion amount detection section 732, into a drive pulse duty value for each light emitting area. Drive duty operation section 733 determines the drive duty for each light emitting area, by applying a predetermined conversion formula to the corrected amount of motion acquired per image display area, and determines the result as the drive duty to specify for each light emitting area.

FIG. 9A shows one example of a method of calculating drive duty based on the corrected amount of motion.

<7-1-3. Upper-Limit Motion Amount Setting Section>

Upper-limit motion amount setting section 737 performs an operation for calculating and setting the upper-limit motion amount value, which is the upper-limit value of the corrected amount of motion per image display area, from estimated power consumption of light emitting section 121. Upper-limit motion amount setting section 737 constitutes a drive condition changing section to change the range of drive conditions that can be designated.

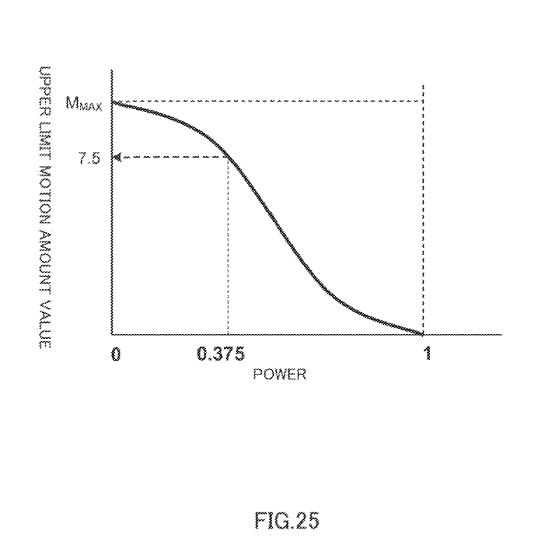

FIG. 25 shows a method of calculating the upper-limit motion amount value based on estimated power consumption, by graphs showing the relationship between power and the upper-limit amount of motion. In the example shown in FIG. 24, when estimated power consumption is 0, which is the minimum value, the upper-limit amount of motion calculated then is M_{MAX}, which is the maximum value. As estimated power consumption increases, the upper-limit value to be calculated decreases gradually, and, when estimated power consumption is 1, which is the maximum value, the upper-limit value of the amount of motion calculated then is 0, which is the minimum value. For example, when estimated power consumption is 0.375, the upper-limit motion amount value to be calculated becomes 7.5. The specific numerical values shown in FIG. 24 are only examples and can be changed variously.

The upper-limit motion amount value, once set, is fed back to motion amount correction section 732, and motion amount correction section 732 corrects the detected amount of motion based on this value. Then, drive duty operation section 733 calculates drive duty based on the corrected amount of motion output from motion amount correction section 732, and drive current operation section 134 determines the peak value depending on the drive duty calculated in drive duty operation section 733.

For example, when upper-limit motion amount setting section 737 sets the upper-limit value of the amount of motion to M_{MAX}, the range of corrected amounts of motion that can be output from motion amount correction section 732 becomes 0-M_{MAX}. In this case, the range of drive duty that can be determined by drive duty operation section 733 is 50-100% (FIG. 9A). With the present embodiment, the drive duty that is determined in drive duty operation section 733 is designated as a drive condition, so that the range of drive duty that can be designated as a drive condition when the upper-limit value of the amount of motion is M_{MAX} becomes 50-100%. Furthermore, the range of peak values that can be determined based on the drive duty calculation result, is 50-125 mA (FIG. 10). With the present embodiment, the peak value determined by drive current operation section 134 is designated as a drive condition, so that the range of peak values that can be designated as a drive condition when the upper-limit value of the amount of motion is 50-125 mA.

Then, when the upper-limit value of the amount of motion set by upper-limit motion amount setting section 737 changes to, for example, 7.5, then, the maximum value of the corrected amount of motion that can be output from motion amount correction section 732 changes to 7.5. Consequently, the range of corrected amounts of motion that can be output from motion amount correction section 732 changes to 0-7.5 (FIG. 24). In this case, the range of drive duty that can be designated as a drive condition changes to 67-100% (FIG. 9A), and, furthermore, the range of peak values that can be designated as a drive condition changes to 50-80 mA (FIG. 10).

By this means, upper-limit motion amount setting section 737 changes the rate of drive conditions that can be designated, based on estimated power consumption.

With the present embodiment, the drive duty that is calculated based on a corrected amount of motion and a drive duty that is designated as a drive condition are always equal. Then, a peak value is determined according to the calculation result of drive duty based on the corrected amount of motion. Consequently, upper-limit motion amount setting section 737 does not actively set the value for limiting the range that can be designated with respect to drive duty and peak values. Instead, upper-limit motion amount setting section 737 is able to change the range of both drive duty and peak values that can be designated, based on estimated power consumption, by setting the upper-limit value of the corrected amount of motion on a variable basis based on estimated power consumption.

Furthermore, upper-limit motion amount setting section 737 sets the upper-limit value alone, not the lower-limit value, for the corrected amount of motion. If drive duty decreases significantly, the peak value increases significantly in response to this, and cases might occur where this causes the lowering of efficiency of light emission and significant increase of power consumption in light emitting section 121. Consequently, by setting the upper-limit value of the corrected amount of motion so that excessive decrease of drive duty is prevented, it is possible to reduce the increase of power consumption in light emitting section 121.

Furthermore, upper-limit motion amount setting section 737 sets a lower upper-limit motion amount value when greater power consumption is estimated. Consequently, when lower power consumption is estimated, a higher upper-limit motion amount value is set. Consequently, under the circumstance where video blur is prone to occur such as when the amount of motion in an image is large, it is possible to improve image blur by increasing the maximum value of the corrected amount of motion that can be output so that drive duty can be decreased.

### Embodiment 8

Embodiment 8 of the present invention will be described below. The liquid crystal display apparatus of the present embodiment has the same basic configuration as the liquid crystal display apparatus of the earlier embodiment. Consequently, parts that are the same as in the earlier embodiment or parts that are equivalent to the earlier embodiment will be assigned the same reference numerals without further explanations, and the differences will be mainly explained.

A case will be described with the present embodiment where a reduction coefficient for the amount of motion in an image, which serves as the basis of calculation of drive duty, is set on a variable basis, according to estimated power consumption.

<8-1. Configuration of Liquid Crystal Display Apparatus>

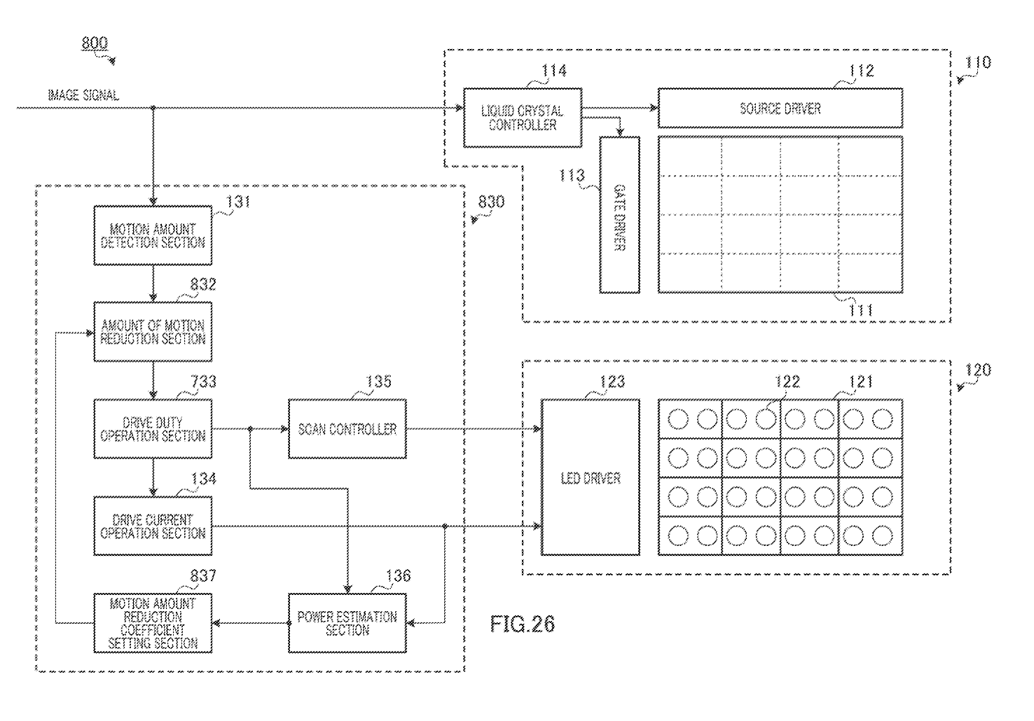

FIG. 26 shows a configuration of a liquid crystal display apparatus according to the present embodiment. Liquid crystal display apparatus 800 has drive control section 830, instead of drive control section 130. Drive control section 830 is an operation processing apparatus having motion amount detection section 131, motion amount reduction section 832, drive duty operation section 733, drive current operation section 134, scan controller 135, power estimation section 136 and motion amount reduction coefficient setting section 737, and controls drive conditions including the duties and peak values of drive pulses on a per light emitting area basis based on an input image signal in each image display area.

<8-1-1. Motion Amount Reduction Section>

Motion amount reduction section 832 performs an operation for reducing the detected amount of motion (that is, the amount of motion before reduction) per image display area, output from motion amount detection section 131.

Motion amount reduction section 832 reduces the amount of motion before reduction according to the motion amount reduction coefficient set in motion amount reduction coefficient setting section 837, and outputs the reduced, detected amount of motion per image display area (reduced amount of motion).

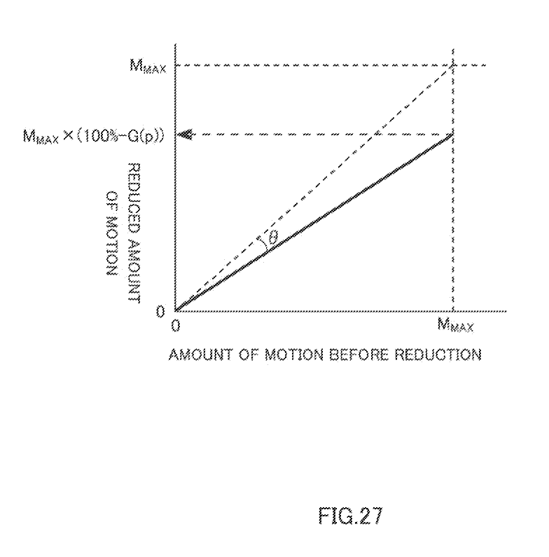

A motion amount reduction coefficient is a function of estimated power consumption, so that p is the estimated power consumption and G(p) [%] is the motion amount reduction coefficient, and motion amount reduction section 832 calculates the reduced amount of motion so that the amount of motion before correction is reduced by G(p) %. Then, as shown in FIG. 27, if the amount of correction before reduction is, for example, M_{MAX}, the reduced amount of motion to be output is M_{MAX}×(100%-G(p)).

<8-1-2. Motion Amount Reduction Coefficient Setting Section>

Motion amount reduction coefficient setting section 837 performs an operation of calculating and setting a reduction coefficient for the detected amount of motion per image display area, from the estimated power consumption in light emitting section 121. Motion amount reduction coefficient setting section 837 constitutes a drive condition changing section that changes the designatable range of drive conditions.

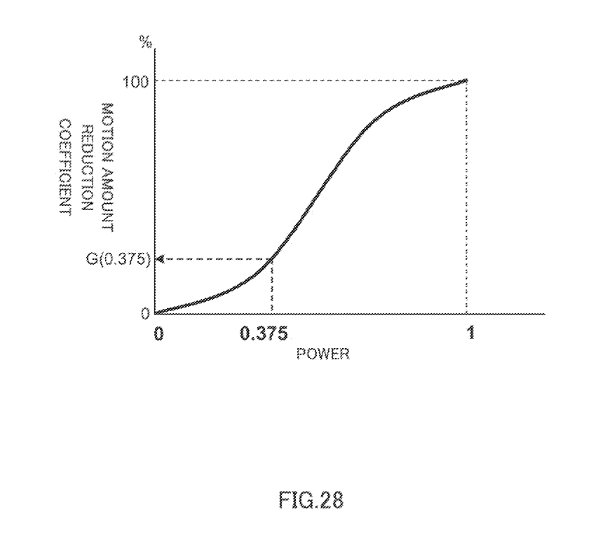

FIG. 28 shows an example of a method of calculating a motion amount reduction coefficient based on estimated power consumption, by graphs showing the relationships between power and the reduced amount of motion. As stated earlier, the motion amount reduction coefficient, which can be represented as function G(p) of estimated power consumption p, becomes 0%, which is the minimum value, when estimated power consumption is the minimum value 0, or, increasing gradually as estimated power consumption increases, becomes 100% when estimated power consumption is the maximum value 1.

A motion amount reduction coefficient, once set, is fed back to motion amount reduction section 832, and motion amount reduction section 832 reduces the detected amount of motion based on this value. Then, drive duty operation section 733 calculates drive duty based on the reduced amount of motion output from motion amount reduction section 832, and drive current operation section 134 determines the peak value based on the drive duty calculated in drive duty operation section 733.

Consequently, when the motion amount reduction coefficient that is set increases or decreases, the magnitude of change, represented by angle θ in FIG. 27 also changes. As a result, the maximum value of the reduced amount of motion that can be output from motion amount reduction section 832 changes, like the maximum value of the corrected amount of motion that can be output from motion amount correction section 732 (FIG. 23) of embodiment 7.

Consequently, similar to embodiment 7, without setting the value to limit the designatable range with respect to drive duty and peak value, by setting the reduction coefficient for the detected amount of motion on a variable basis, it is possible to change the designatable range with respect to both drive duty and peak values based on estimated power consumption.

Also, when greater power consumption is estimated, motion amount reduction coefficient setting section 837 sets a higher motion amount reduction coefficient. Consequently, when lower power consumption is estimated, a lower motion amount reduction coefficient is set. Consequently, under the circumstance where video blur is prone to occur such as when the amount of motion in an image is large, it is possible to improve image blur by increasing the maximum value of the reduced amount of motion that can be output based on need so that drive duty can be decreased.

Also, according to the present embodiment, drive duty changes in all light emitting areas when the motion amount reduction coefficient changes, and drive conditions do not change locally like described above, so that it is possible to reduce the likelihood of identifying unnecessary flicker due to local change of drive conditions.

Now, embodiments of the present invention have been described. Note that the above descriptions have encompassed preferred embodiments of the present invention only by way of example and by no means limit the scope of the present invention. That is to say, the configurations and operations of apparatuses described with the above embodiments are examples, and it is obviously and certainly possible to make various changes, additions, and omissions, in part, within the scope of the present invention.

For example, cases have been described with the above embodiments, by way of example, where the present invention is applied to a liquid crystal display apparatus. However, even if an optical modulation section has a display section that is different from a display section, it is equally possible to employ other configurations insofar as providing a non-self-luminous configuration. That is to say, the present invention is applicable to non-self-luminous display apparatuses other than liquid crystal display apparatuses.

The above embodiments can be implemented in various combinations.

The disclosure of Japanese Patent Application No. 2009-228299, filed on Sep. 30, 2009, including the specification, drawings and abstract, is incorporated herein by reference in its entirety.

### INDUSTRIAL APPLICABILITY

The backlight apparatus and display apparatus of the present invention provide an advantage of reducing the increase of the maximum power consumption of a backlight apparatus and therefore is useful as a backlight apparatus and display apparatus of a backlight scan scheme.

### REFERENCE SIGNS LIST

100, 200, 300, 400, 500, 600, 700, 800 Liquid crystal display apparatus
110 Liquid crystal panel section
111 Liquid crystal panel
112 Source driver
113 Gate driver
114 Liquid crystal controller
120 Illuminating section
121 Light emitting section
122 LED
123 LED driver
130, 230, 330, 430, 530, 630, 730, 830 Drive control section
131 Motion amount detection section
133, 733 Drive duty operation section
134, 634 Drive current operation section
135 Scan controller
136, 336, 436, 536 Power estimation section
137 Lower-limit duty value setting section
141 Constant current circuit
142 Communication OF
143 DAC
144 Switch
151 1V delay section
152 Macroblock motion amount operation section
153 Maximum value calculation section
231, 631 First drive duty operation section
232 Light adjustment value operation section
233 Second drive duty operation section
638 Upper-limit current value setting section
732 Motion amount correction section
737 Upper-limit motion amount setting section
832 Motion amount reduction section
837 Motion amount reduction coefficient setting section

1. A backlight apparatus comprising:
a light emitting section that has a plurality of light emitting areas to emit light individually;
a power estimation section that estimates power consumption of the light emitting section;
a drive condition changing section that changes a range that can be designated with respect to drive conditions including duties and peak values of drive pulses for allowing the plurality of light emitting areas to emit light, in accordance with change of estimated power consumption;
a drive condition designating section that designates the drive conditions of the plurality of light emitting areas in changing ranges; and
a drive section that drives the plurality of light emitting areas individually based on the designated drive conditions.

2. The backlight apparatus according to claim 1, wherein the drive condition changing section sets a lower-limit value of duty that can be designated, on a variable basis, in accordance with change with the estimated power consumption.

3. The backlight apparatus according to claim 2, wherein the drive condition changing section sets a higher lower-limit value when greater power consumption is estimated.

4. The backlight apparatus according to claim 1, wherein:
the drive condition changing section sets a lower-limit value for duty on a variable basis in accordance with change of estimated power consumption;
the drive condition designating section calculates the duty to designate for each of the plurality of light emitting areas according to the lower-limit value that is set, and determines the peak value to designate for each of the plurality of light emitting areas in accordance with the duty that is calculated.

5. The backlight apparatus according to claim 4, wherein the drive condition changing section sets a higher lower-limit value when greater power consumption is estimated.

6. The backlight apparatus according to claim 1, further comprising:
a motion detection section that detects an amount of motion in an image in each of the plurality of image display areas corresponding to the plurality of light emitting areas; and
a light adjusting section that calculates a light adjustment value for each of the plurality of light emitting areas, wherein:
the drive condition changing section sets the lower-limit value for duty on a variable basis in accordance with change with estimated power consumption; and
the drive condition designating section:
calculates a duty, based on the detected amount of motion, for each of the plurality of light emitting areas, in accordance with the lower-limit value that is set;
determines the duty to designate for each of the plurality of light emitting areas based on the calculated duty and the calculated light adjustment value; and
determines the peak value to designate for each of the plurality of light emitting areas in accordance with the calculated duty.

7. The backlight apparatus according to claim 1, wherein the drive condition changing section sets an upper-limit value for a peak value that can be designated, on a variable basis, in accordance with change of estimated power consumption.

8. The backlight apparatus according to claim 7, wherein the drive condition changing section sets a lower upper-limit value for the peak value when greater power consumption is estimated.

9. The backlight apparatus according to claim 1, further comprising:
a motion detection section that detects the amount of motion in an image in each of a plurality of image display areas corresponding to a plurality of light emitting areas; and
a motion amount correction section that outputs a corrected amount of motion, which is obtained by correcting the detected amount of motion, wherein:
the drive condition changing section determines a drive condition to designate for each of the plurality of light emitting areas based on the corrected amount of motion that is output;
the drive condition changing section sets an upper-limit value for the corrected amount of motion in accordance with change of estimated power consumption; and
the motion amount correction section corrects the detected amount of motion in accordance with the upper-limit value that is set.

10. The backlight apparatus according to claim 9, wherein the drive condition changing section sets a lower upper-limit value when greater power consumption is estimated.

11. The backlight apparatus according to claim 1, further comprising:
a motion detection section that detects the amount of motion in an image in each of a plurality of image display areas corresponding to the plurality of light emitting areas; and
a motion amount reduction section that reduces the detected amount of motion according to a reduction coefficient, wherein:
the drive condition designating section determines a drive condition to designate for each of the plurality of light emitting areas based on the reduced amount of motion; and
the drive condition changing section sets the reduction coefficient to use to reduce the detected amount of motion, on a variable basis, in accordance with change of estimated power consumption.

12. The backlight apparatus according to claim 11, wherein the drive condition changing section sets a higher reduction coefficient when greater power consumption is estimated.

13. The backlight apparatus according to claim 1, wherein the power estimation section estimated power consumption in each of the plurality of light emitting areas and calculates the power consumption of the light emitting section from estimated power consumption.

14. The backlight apparatus according to claim 13, wherein:
the drive condition designating section determines the duty and peak value for each of the plurality of light emitting areas; and
the power estimation section estimates power consumption in each of a plurality of light emitting areas based on a product of the determined duty and peak value.

15. The backlight apparatus according to claim 13, further comprising a light adjustment section that calculates a light adjustment value for each of the plurality of light emitting areas,
wherein the power estimation section estimates the calculated light adjustment value as power consumption in each of the plurality of light emitting areas.

16. The backlight apparatus according to claim 15, wherein:
the drive condition designating section determines a peak value to designate for each of the plurality of light emitting areas; and
the power estimation section corrects the calculated power consumption of the light emitting section based on the determined peak value.

17. The backlight apparatus according to claim 15, wherein:
the drive condition designating section determines the peak value to designate for each of the plurality of light emitting areas; and
the power estimation section corrects the estimated power consumption in each of the plurality of light emitting areas based on the determined peak value.

18. The backlight apparatus according to claim 15, further comprising a motion detection section that detects the amount of motion in an image in each of the plurality of image display areas corresponding to the plurality of light emitting areas,
wherein the power estimation section corrects the calculated power consumption of the light emitting section based on the detected amount of motion.

19. The backlight apparatus according to claim 15, further comprising a motion detection section that detects the amount of motion in an image in each of the plurality of image display areas corresponding to the plurality of light emitting areas,
wherein the power estimation section corrects the estimate power consumption of each of the plurality of light emitting areas based on the detected amount of motion.

20. A display apparatus comprising:
the backlight apparatus of claim 1; and
a light modulation section that displays an image by modulating an illuminating light from the plurality of light emitting areas in accordance with an image signal.
